(19) United States
(12) Patent Application Publication
(10) Pub. No.: US 2026/0229760 A1
(43) Pub. Date: Aug. 6, 2026

(54) WAVEGUIDE

(71) Applicant: Panasonic Industry Co., Ltd., Osaka (JP)

(72) Inventors: Tomoki ABE, Kanagawa (JP); Koji TAKINAMI, Kanagawa (JP); Tomohiro MURATA, Kanagawa (JP); Ryosuke HASABA, Kanagawa (JP)

(73) Assignee: Panasonic Industry Co., Ltd., Osaka (JP)

(21) Appl. No.: 19/158,335

(22) PCT Filed: Feb. 19, 2024
(86) PCT No.: PCT/JP2024/005836

§ 371 Date: Aug. 20, 2025

(30) Foreign Application Priority Data
Feb. 22, 2023 (JP) 2023-026210

(51) Int. Cl. H01P 3/02

(52) U.S. Cl. CPC H01P 3/02

(57) ABSTRACT

This waveguide comprises: a dielectric layer; a first conductor layer layered in the layering direction of the dielectric layer; a second conductor layer layered in the layering direction of the dielectric layer at a position that differs from that of the first conductor layer; a plurality of first conductor vias that electrically connect the first conductor layer and the second conductor layer; and a connection section that is surrounded by the first conductor layer, the second conductor layer, and the plurality of first conductor vias, is present in a waveguide portion through which electromagnetic waves pass, and electrically connects two or more second conductor vias disposed in the vicinity of specific locations where scattering of electromagnetic waves occurs.

### TECHNICAL FIELD

The present disclosure relates to a waveguide.

### BACKGROUND ART

A post-wall waveguide is a type of transmission line that transmits high-frequency signals such as microwaves, millimeter waves, and terahertz waves. The post-wall waveguide includes a dielectric layer, two conductor layers disposed with the dielectric layer therebetween, and a conductor via that connects the two conductor layers.

For example, Patent Literature (hereinafter, referred to as PTL) 1 discloses a structure in which two post-wall waveguides having the same thickness (for example, the same number of layers) and different center positions in the lamination direction are connected to each other. In this structure, the two post-wall waveguides are connected to each other with a coupling window.

### CITATION LIST

### Patent Literature

PTL 1
Japanese Patent Application Laid-Open No. 2008-300934

### SUMMARY OF INVENTION

In the post-wall waveguide disclosed in PTL 1, the surface area of a conductor is inevitably increased, so that a loss in the conductor is increased.

One non-limiting and exemplary embodiment facilitates providing a waveguide in which a loss can be suppressed.

A waveguide according to an embodiment of the present disclosure includes: a first conductor layer laminated on the dielectric layer in a lamination direction of the dielectric layer; a second conductor layer laminated on the dielectric layer at a position different from the first conductor layer in the lamination direction; a plurality of first conductor vias that electrically connect the first conductor layer with the second conductor layer; and a connector that electrically connects two or more second conductor vias with each other, the two or more second conductor vias being provided in a vicinity of a specific location in which scattering of an electromagnetic wave occurs, the specific location being located in a waveguide portion through which the electromagnetic wave passes and which is surrounded by the first conductor layer, the second conductor layer, and the plurality of first conductor vias.

According to an embodiment of the present disclosure, loss in a waveguide can be suppressed.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1A is a perspective view illustrating an example of a post-wall waveguide illustrated in PTL 1;

FIG. 1B is a cross-sectional view taken along line A-A′ of FIG. 1A and cut along the X-Z plane;

FIG. 2 is a perspective view illustrating an example of a post-wall waveguide according to Embodiment 1 of the present disclosure;

FIG. 3 is a top view of the post-wall waveguide according to Embodiment 1 of the present disclosure as viewed from the positive direction of the Z axis;

FIG. 4 is an A-A′ cross-sectional view taken along line A-A′ of FIG. 3 and cut along the X-Z plane;

FIG. 5 is a B-B′ cross-sectional view taken along line B-B′ of FIG. 3 and cut along the X-Z plane;

FIG. 6 is a C-C′ cross-sectional view taken along line C-C′ of FIG. 3 and cut along the Y-Z plane;

FIG. 7 illustrates an example of a frequency response of the post-wall waveguide according to Embodiment 1 of the present disclosure;

FIG. 8 illustrates an example of an electric field distribution in the post-wall waveguide according to Embodiment 1 of the present disclosure;

FIG. 9 is a perspective view illustrating an example of a post-wall waveguide according to Embodiment 2 of the present disclosure;

FIG. 10 is a top view of the post-wall waveguide according to Embodiment 2 of the present disclosure as viewed from the positive direction of the Z axis;

FIG. 11 is an A-A′ cross-sectional view taken along line A-A′ of FIG. 10 and cut along the X-Z plane;

FIG. 12 is a B-B′ cross-sectional view taken along line B-B′ of FIG. 10 and cut along the X-Z plane;

FIG. 13 is a C-C′ cross-sectional view taken along line C-C′ of FIG. 10 and cut along the Y-Z plane;

FIG. 14 illustrates an example of a frequency response of the post-wall waveguide according to Embodiment 2 of the present disclosure;

FIG. 15 illustrates an example of an electric field distribution in the post-wall waveguide according to Embodiment 2 of the present disclosure;

FIG. 16 is a perspective view illustrating an example of a post-wall waveguide according to Embodiment 3 of the present disclosure;

FIG. 17 is a top view of the post-wall waveguide according to Embodiment 3 of the present disclosure as viewed from the positive direction of the Z axis;

FIG. 18 is an A-A′ cross-sectional view taken along line A-A′ of FIG. 17 and cut along the X-Z plane;

FIG. 19 is a B-B′ cross-sectional view taken along line B-B′ of FIG. 17 and cut along the X-Z plane;

FIG. 20 is a C-C′ cross-sectional view taken along line C-C′ of FIG. 17 and cut along the Y-Z plane;

FIG. 21 illustrates an example of a frequency response of the post-wall waveguide according to Embodiment 3 of the present disclosure;

FIG. 22 illustrates an example of an electric field distribution in the post-wall waveguide according to Embodiment 3 of the present disclosure;

FIG. 23 is a perspective view illustrating an example of a post-wall waveguide according to Embodiment 4 of the present disclosure;

FIG. 24 illustrates an example of a frequency response of the post-wall waveguide according to Embodiment 4 of the present disclosure; and

FIG. 25 illustrates an example of an electric field distribution in the post-wall waveguide according to Embodiment 4 of the present disclosure.

### DESCRIPTION OF EMBODIMENTS

Hereinafter, the embodiments of the present disclosure will be described in detail with reference to the drawings as appropriate. However, more detailed explanation than necessary may be omitted. For example, detailed explanation of already well-known matters or duplicate explanation of substantially the same configuration may be omitted. This is to avoid the following explanation becoming unnecessarily redundant and to facilitate understanding by those skilled in the art.

It should be noted that the accompanying drawings and the following description are provided to enable those skilled in the art to fully understand the present disclosure, and are not intended to limit the subject matter described in the claims.

In various drawings, some elements may be omitted and some elements may not be drawn to scale in order to make the drawings easy to see.

### Knowledge Leading to Present Disclosure

A post-wall waveguide is a type of transmission line that transmits high-frequency signals such as microwaves, millimeter waves, and terahertz waves. The post-wall waveguide includes a dielectric layer, two conductor layers disposed with the dielectric layer therebetween, and a conductor via that connects the two conductor layers. The post-wall waveguide has a feature of low loss at a high frequency band as compared with other transmission lines such as a microstrip line, and thus the post-wall waveguide is widely used, for example, in a high frequency band equal to or higher than a millimeter wave band.

However, the loss in the post-wall waveguide increases with an increase in the frequency of a signal to be transmitted, as in the case of other transmission lines (for example, a microstrip line). The increase in loss accompanied by the increase in the frequency of the signal to be transmitted is mainly caused by a decrease in effective conductivity due to the roughness of a conductor surface that cannot be ignored because of a skin effect, and an increase in dielectric loss due to increase in dielectric loss tangent. Therefore, it is desired to suppress the loss in the post-wall waveguide as much as possible even in the post-wall waveguide having a lower loss than other transmission lines.

In addition, it is desired to improve a degree of freedom in designing the post-wall waveguide in addition to the suppression of the loss. For example, it is desired to improve the degree of freedom in design such that the thickness of the post-wall waveguide can be changed.

For example, for converting from a surface layer line such as a microstrip line to a post-wall waveguide embedded inside a dielectric substrate is performed, it is desired to change a position of the post-wall waveguide in a lamination direction. In addition, when a waveguide tube and a post-wall waveguide are connected to each other, with respect to the thickness of the connection section between the waveguide tube and the post-wall waveguide, the thickness that can achieve the lowest loss is generally different from the thickness of the post-wall waveguide at which the loss is lowest. Therefore, it is desired to change the thickness of the post-wall waveguide in the vicinity of the connection section of the waveguide tube. As described above, in the connection of the post-wall waveguide with another transmission line, such as a microstrip line or a waveguide tube, it is desired to suppress the loss of the waveguide while achieving a satisfactory degree of freedom in the design.

For example, PTL 1 shows an example of improving the degree of freedom in designing the post-wall waveguide.

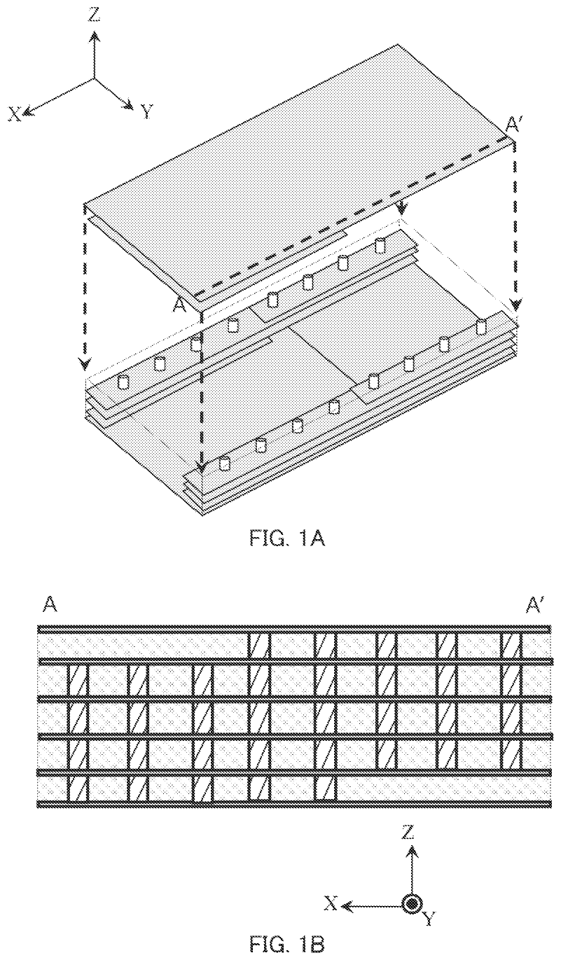

FIG. 1A is a perspective view illustrating an example of a post-wall waveguide illustrated in PTL 1. FIG. 1B is a cross-sectional view taken along line A-A′ of FIG. 1A and cut along the X-Z plane.

As illustrated in FIGS. 1A and 1B, PTL 1 discloses a structure in which two post-wall waveguides having the same thickness (for example, the same number of layers) and different center positions in the lamination direction are connected to each other. In the structure disclosed in PTL 1, two post-wall waveguides that share some layers of a multilayer dielectric substrate are connected to each other, thereby realizing movement of the post-wall waveguides in the lamination direction while reducing reflection loss over a wide band. In addition, in the structure disclosed in PTL 1, all the conductor vias are connected by conductors, thereby suppressing leakage of electromagnetic waves to the outside of the waveguide caused by scattering at a coupling portion.

However, in the post-wall waveguide disclosed in PTL 1, all the conductor vias are electrically connected by the conductors as illustrated in FIGS. 1A and 1B, and thus the surface area of the conductors is increased. Therefore, in particular in the high frequency band, loss in the conductor (hereinafter, a conductor loss) is increased.

Therefore, in the following embodiments, a post-wall waveguide that can reduce the loss will be described. In addition, in the following embodiments, it will be described that the post-wall waveguide capable of reducing the loss can suppress the loss and achieve a satisfactory degree of freedom in the design.

### Embodiment 1

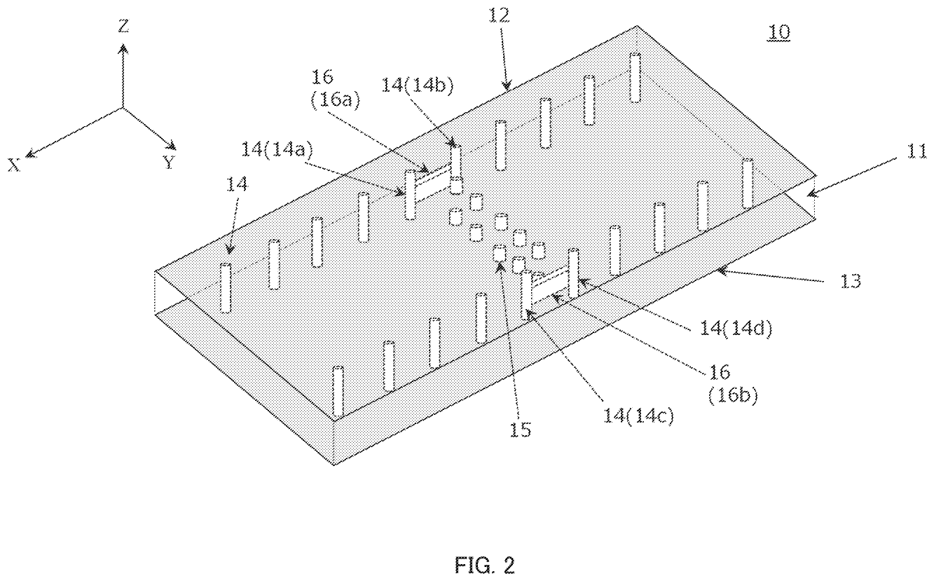

FIG. 2 is a perspective view illustrating an example of post-wall waveguide 10 according to Embodiment 1. FIG. 2 illustrates post-wall waveguide 10 and the X axis, the Y axis, and the Z axis defined with respect to post-wall waveguide 10.

Post-wall waveguide 10 includes dielectric layer 11, first conductor layer 12, second conductor layer 13, conductor vias 14, conductors 15, and connection conductors 16. For convenience of illustration, FIG. 2 illustrates post-wall waveguide 10 with dielectric layer 11 seen through.

A plane along a surface, on which dielectric layer 11, first conductor layer 12, and second conductor layer 13 are provided, is defined as an X-Y plane. The X-Y plane is a plane defined by the X axis and the Y axis. In this case, dielectric layer 11, first conductor layer 12, and second conductor layer 13 are provided along the X-Y plane.

The X axis indicates an axis along a direction in which post-wall waveguide 10 extends. In this case, the X axis indicates an axis along a traveling direction (or transmission direction) of electromagnetic waves transmitted through post-wall waveguide 10. Hereinafter, as an example, the electromagnetic waves are transmitted in post-wall waveguide 10 in the positive direction of the X axis. In post-wall waveguide 10, the electromagnetic waves may be transmitted in the negative direction of the X axis.

The Y-axis indicates an axis orthogonal to the X-axis. In the following description, the positive direction of the Y-axis corresponds to “left” or “leftward”, and the negative direction of the Y-axis corresponds to “right” or “rightward”.

The Z axis is an axis orthogonal to the X axis and the Y axis and extending along the thickness direction of post-wall waveguide 10. The thickness direction may also be referred to as the height direction or the lamination direction. In addition, in the following description, the positive direction of the Z axis corresponds to “up” or an “upward”, and the negative direction of the Z axis corresponds to “down” or a “downward”.

In addition, hereinafter, a plane defined by the X axis and the Z axis may be referred to as the X-Z plane, and a plane defined by the Y axis and the Z axis may be referred to as the Y-Z plane.

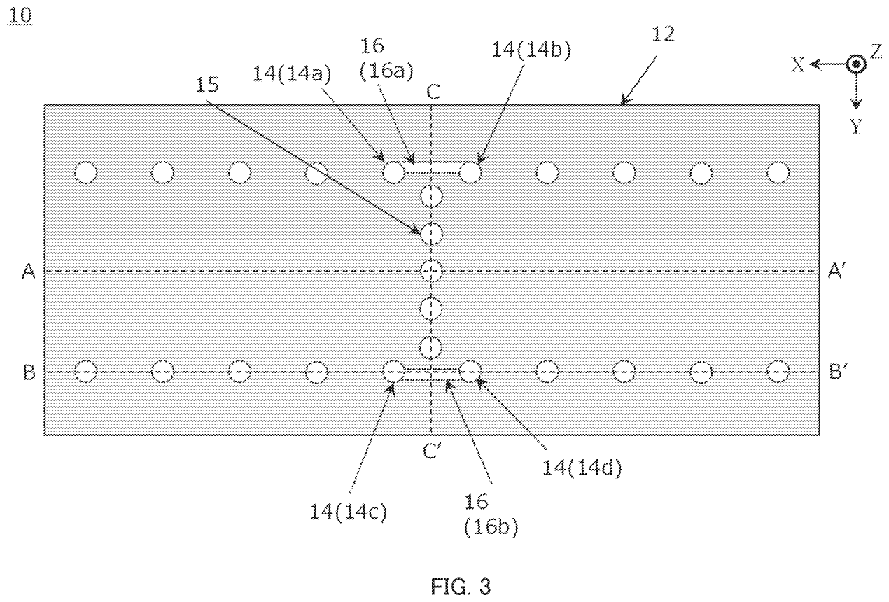

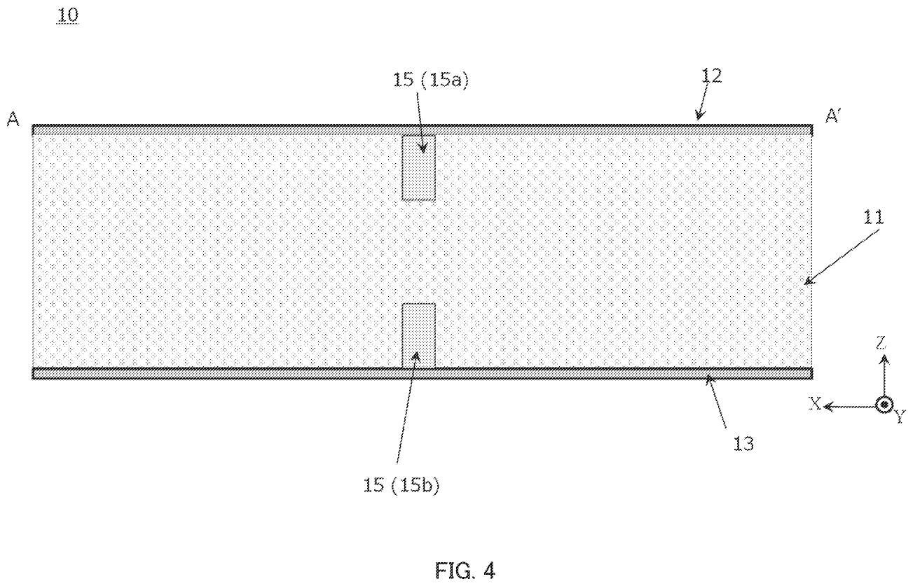

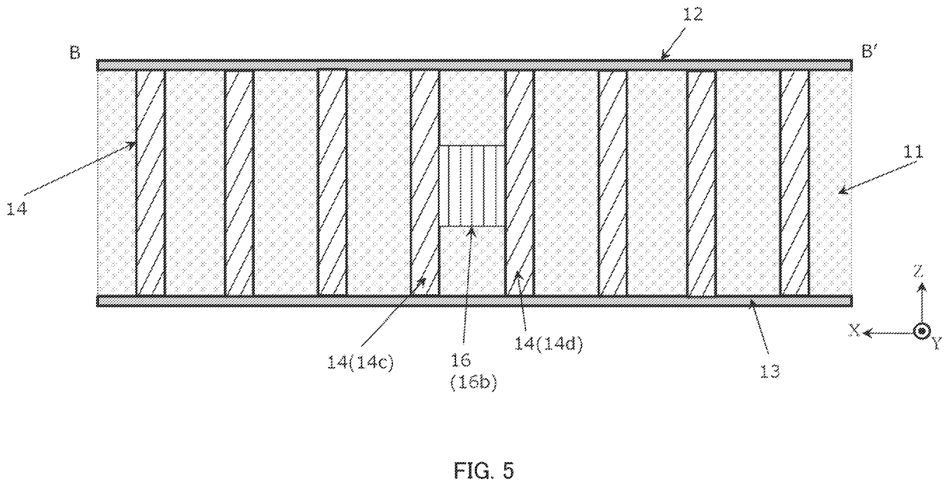

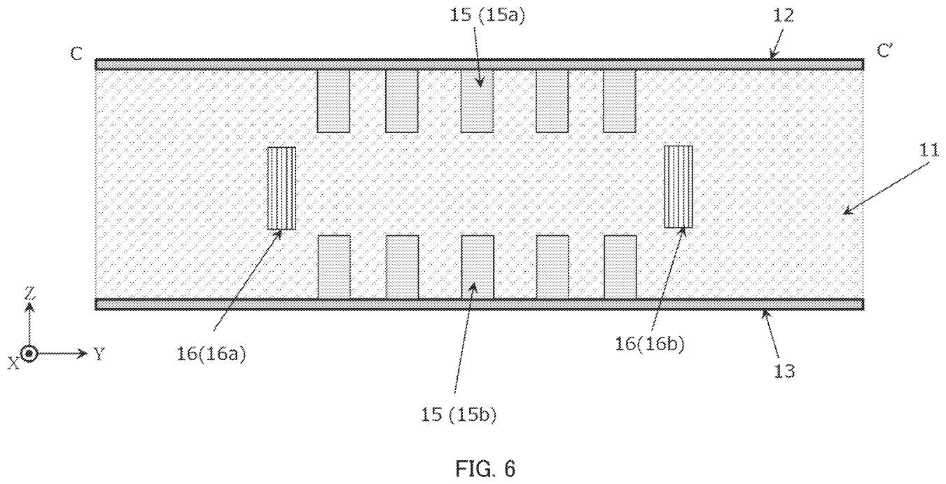

FIG. 3 is a view (hereinafter, a top view) of post-wall waveguide 10 according to Embodiment 1 as viewed from the positive direction of the Z axis. FIG. 4 is a cross-sectional view (hereinafter, an A-A′ cross-sectional view) taken along line A-A′ of FIG. 3 and cut along the X-Z plane. FIG. 5 is a cross-sectional view (hereinafter, a B-B′ cross-sectional view) taken along line B-B′ of FIG. 3 and cut along the X-Z plane. FIG. 6 is a cross-sectional view (hereinafter, a C-C′ cross-sectional view) taken along line C-C′ of FIG. 3 and cut along the Y-Z plane. Post-wall waveguide 10 will be described with reference to FIGS. 2 to 6. Since post-wall waveguide 10 according to Embodiment 1 extends in a substrate, FIGS. 2 to 6 may illustrate a part of the configuration of post-wall waveguide 10. For example, some drawings may be enlarged views of specific locations of other drawings. Similarly, in the drawings of each of the following embodiments, some of the drawings may be enlarged views of specific locations of other drawings.

First conductor layer 12 is provided on an upper surface (surface in the positive direction of the Z axis) of dielectric layer 11, and second conductor layer 13 is provided on a lower surface (surface in the negative direction of the Z axis) of dielectric layer 11. First conductor layer 12 and second conductor layer 13 are parallel to each other.

Dielectric layer 11 is interposed between first conductor layer 12 and second conductor layer 13. Dielectric layer 11 may be one layer or may be composed of a plurality of dielectric layers.

Conductor via 14 (first conductor via) extends in dielectric layer 11 along the thickness direction and electrically connects first conductor layer 12 with second conductor layer 13. A plurality of conductor vias 14 face each other at a specific interval in the Y axis direction. The plurality of conductor vias 14 are provided so as to be arranged along the X axis.

The length of conductor via 14, the interval between conductor vias 14 facing each other in the Y axis direction, and the interval between conductor vias 14 adjacent to each other in the X axis direction may be determined by the frequency (or wavelength) of the electromagnetic wave transmitted through post-wall waveguide 10. For example, the interval between conductor vias 14 adjacent to each other in the X axis direction is equal to or less than half of the wavelength of the electromagnetic waves to be transmitted. The width of post-wall waveguide 10 may be, for example, equal to or more than 1/50 of the wavelength.

In post-wall waveguide 10, the electromagnetic waves are transmitted in a range in dielectric layer 11—the range is surrounded by first conductor layer 12, second conductor layer 13, and conductor vias 14. Hereinafter, the range in which the electromagnetic waves are transmitted may be referred to as a “waveguide portion” of post-wall waveguide 10. For example, in post-wall waveguide 10, first conductor layer 12 and second conductor layer 13 correspond to the wall of an upper surface (upper portion) and the wall of a lower surface (lower portion) of the waveguide portion, respectively, and conductor vias 14 correspond to a side wall of the waveguide portion.

Conductor 15 has a columnar shape and corresponds to an example of a scatterer in the waveguide portion. Post-wall waveguide 10 may include a plurality of conductors 15. By providing conductor 15, the wavelength of the electromagnetic wave transmitted in post-wall waveguide 10 is controlled. For example, for changing (shortening) an effective wavelength in the waveguide, the plurality of conductors 15 having a columnar shape may be arranged in the transmission direction (for example, conductors 15 may be arranged in the X direction). The scatterer at least partly scatters the transmitted electromagnetic waves. The location of the waveguide portion where conductor 15 is provided may correspond to a location where the electromagnetic waves are at least partly scattered and/or a location that is electrically discontinuous.

Connection conductor 16 (second conductor via) electrically connects two or more conductor vias 14 located in the vicinity of conductor 15 with each other. For example, conductor via 14a and conductor via 14b on the right side and in the vicinity of conductor 15 serving as the scatterer are connected to each other by connection conductor 16a, and conductor via 14c and conductor via 14d on the left side and in the vicinity of conductor 15 are connected to each other by connection conductor 16b. In this case, conductor vias 14 excluding conductor via 14a, conductor via 14b, conductor via 14c, and conductor via 14d does not have to be connected by connection conductor 16. The size and the number of connection conductor(s) 16 are not limited. In addition, connection conductor 16 does not have to connect all conductor vias 14. For example, as illustrated in FIG. 2, when conductor vias 14 are configured in two rows of three each, connection conductor 16 may connect two conductor vias 14 in each row or may connect all conductor vias 14.

In the present embodiment, connection conductor 16 electrically connects conductor vias 14 located in the vicinity of conductor 15. In addition, on each of the left side and the right side, for example, connection conductor 16 connects conductor via 14 closest to conductor 15 with conductor via 14 second closest to conductor 15. Alternatively, on each of the left side and the right side, connection conductor 16 may connect conductor via 14 closest to conductor 15 with at least one conductor via adjacent to conductor via 14 closest to conductor 15. Alternatively, on each of the left side and the right side, connection conductor 16 may connect conductor via 14 most affected by the scattering of conductor 15 with conductor via 14 second most affected by the scattering of conductor 15. Alternatively. on each of the left side and the right side, connection conductor 16 may connect conductor vias at a location where the leakage of the electromagnetic waves scattered by conductor 15 is equal to or higher than a predetermined level among the intervals between the plurality of conductor vias 14. For example, the leakage of the electromagnetic waves may be analyzed by computer simulation or the like.

In FIGS. 2 to 6, an example is illustrated in which connection conductor 16 connects two conductor vias 14 located in the vicinity of conductor 15, but three or more conductor vias 14 may be connected to each other by connection conductor 16. For example, on each of the left side and the right side, connection conductor 16 may connect three conductor vias 14 from conductor via 14 closest to conductor 15 to conductor via 14 third closest to conductor 15. Alternatively, on each of the left side and the right side, connection conductor 16 may connect conductor vias at two or more locations where the leakage of the electromagnetic waves scattered by conductor 15 is equal to or higher than the predetermined level among the intervals between the plurality of conductor vias 14. For example, the leakage of the electromagnetic waves may be analyzed by computer simulation or the like.

In FIGS. 2 to 6, an example is illustrated in which connection conductor 16 connects two conductor vias 14 located in the vicinity of conductor 15 on each of the left side and the right side, but connection conductor 16 may connect two conductor vias 14 located in the vicinity of conductor 15 on either the left side or the right side. For example, when the number of conductors 15 is larger on the left side, connection conductor 16 may connect two conductor vias 14 located in the vicinity of conductor 15 on the left side and does not have to connect conductor vias 14 on the right side. In addition, the number of conductor vias 14 connected on the left side may be different from the number of conductor vias 14 connected on the right side.

The number and/or position of conductor via(s) 14 connected by connection conductor 16 may be determined by at least one of the position of conductor 15, the number of conductors 15, the size of conductor 15, the shape of conductor 15, the size of post-wall waveguide 10, and the frequency of the electromagnetic wave. For example, when a plurality of conductors 15 are provided in a wider range along the X axis, the leakage of the electromagnetic waves scattered by conductor 15 also extends over a wider range along the X axis, and thus the number of conductor vias 14 connected by connection conductor 16 may be increased.

As illustrated in FIGS. 4 and 6, conductor 15 inside the waveguide portion includes conductor 15a in contact with first conductor layer 12 and conductor 15b in contact with second conductor layer 13. Conductor 15 does not have to be in contact with first conductor layer 12 and/or second conductor layer 13. In addition, conductors 15 do not have to be provided in both the upper portion and the lower portion inside the waveguide portion or do not have to be uniformly provided inside the waveguide portion. For example, the number of the provided conductors 15 may be larger in at least one of the upper portion, the lower portion, the right side, and the left side inside the waveguide portion.

In addition, the shape of conductor 15 is not limited to columnar, and may be a prismatic shape, a pyramidal shape, a conical shape, a spherical shape, or the like. In addition, conductor 15 may have a shape obtained by combining two or more shapes such as a columnar shape, a prismatic shape, a pyramidal shape, a conical shape, and a spherical shape. In addition, the size and/or the number of conductor(s) 15 are not limited, but for example, the height of conductor 15 is equal to or lower than the height of post-wall waveguide 10.

In addition, in Embodiment 1, conductor 15 is shown as an example of the scatterer, but the present disclosure is not limited to thereto. For example, a material of the scatterer may have a dielectric constant different from that of dielectric layer 11 of post-wall waveguide 10. The material of the scatterer may be a dielectric having a dielectric constant different from that of dielectric layer 11, or the scatterer may be a void.

In Embodiment 1, an example is shown in which each of conductor vias 14 electrically connects first conductor layer 12 with second conductor layer 13, but the present disclosure is not limited to thereto. For example, when post-wall waveguide 10 is configured in a multilayer substrate, a plurality of conductor vias (in which a conductor via is stacked immediately above the previous conductor via in the layers of the multilayer substrate) may electrically connect first conductor layer 12 with second conductor layer 13. For example, an example will be described as follows: in a multilayer substrate including three dielectric layers, namely a first layer to a third layer, laminated in order, first conductor layer 12 is provided on an upper portion of the first layer, and second conductor layer 13 is provided on a lower portion of the third layer. In this example, a third conductor via connected to second conductor layer 13 in the third layer, a second conductor via stacked immediately above the third conductor via in the second layer, and a first conductor via connected to first conductor layer 12 in the first layer and stacked immediately above the second conductor via may electrically connect first conductor layer 12 with second conductor layer 13.

As illustrated in FIGS. 2 to 6, connection conductor 16 connects at least two conductor vias 14, so that the at least two connected conductor vias 14 can be at the same potential as each other. Therefore, it is possible to suppress the scattering of the electromagnetic waves passing through the waveguide portion by conductors 15 and the leakage of the electromagnetic waves caused by the propagation (or scattering) between conductors 15.

As described above, the size and the number of connection conductor(s) 16 are not limited. However, from the viewpoint of reducing the conductor loss, it is desirable that connection conductor 16 can suppress the leakage of the electromagnetic waves and is as small as possible.

As the size of connection conductor 16 is increased, the leakage of the electromagnetic waves due to connection conductor 16 can be further suppressed, but on the other hand, there is a possibility that the conductor loss in connection conductor 16 is increased. Therefore, the size of connection conductor 16 may be determined based on a trade-off relationship between the suppression of the leakage of the electromagnetic waves and the increase in the conductor loss.

For example, as the cross-sectional area of conductor 15 disposed inside the waveguide is smaller, the leakage of the electromagnetic waves caused by the reflected waves in conductor 15 and/or the propagation between conductors 15 is relatively reduced. Therefore, when the cross-sectional area of conductor 15 is relatively small, even when connection conductor 16 has a small size, the leakage of the electromagnetic waves can be sufficiently suppressed. In addition, in this case, by reducing the size of connection conductor 16, the conductor loss caused by connection conductor 16 can be suppressed. In this way, the size of connection conductor 16 may be determined based on the amount of the leakage of the electromagnetic waves in accordance with the cross-sectional area of conductor 15 or the like, the amount of the leakage of the electromagnetic waves that can be suppressed by connection conductor 16, and the conductor loss in connection conductor 16.

For example, when the cross-sectional area of conductor 15 in the Y-Z plane is larger than half of the cross-sectional area of post-wall waveguide 10 in the Y-Z plane, the reflected waves are dominant, and the amount of the leakage of the electromagnetic waves is relatively reduced. In this case, the influence of the conductor loss caused by connection conductor 16 may be larger than the amount of the leakage of the electromagnetic waves that can be suppressed by connection conductor 16. Therefore, whether or not conductor vias 14 are connected by connection conductor 16 may be determined based on the cross-sectional area of conductor 15 in the Y-Z plane and the cross-sectional area of post-wall waveguide 10 in the Y-Z plane. For example, when the cross-sectional area of conductor 15 in the Y-Z plane is equal to or less than half of the cross-sectional area of post-wall waveguide 10 in the Y-Z plane, the scattering of the electromagnetic waves and the leakage of the electromagnetic waves may be suppressed by connecting conductor vias 14 by connection conductor 16. When post-wall waveguide 10 includes a plurality of conductors 15, the “cross-sectional area of conductor 15 in the Y-Z plane” may be replaced with the total area of the cross-sectional areas of the plurality of conductors 15 in the Y-Z plane.

In addition, as the width of conductor 15 in the Y-Z plane is larger, the reflected waves are larger, and the amount of the leakage of the electromagnetic waves is relatively reduced. Therefore, as the width of conductor 15 in the Y-Z plane is larger, the influence of the conductor loss caused by connection conductor 16 may be larger than the amount of the leakage of the electromagnetic waves that can be suppressed by connection conductor 16. Therefore, whether or not conductor vias 14 are connected by connection conductor 16 may be determined based on the width of conductor 15 in the Y-Z plane. For example, when the width of conductor 15 in the Y-Z plane is equal to or less than half of the width of post-wall waveguide 10 in the Y-Z plane, the scattering of the electromagnetic waves and the leakage of the electromagnetic waves may be suppressed by connecting conductor vias 14 by connection conductor 16. When post-wall waveguide 10 includes a plurality of conductors 15, the “width of conductor 15 in the Y-Z plane” may be replaced with the total length of the widths of the plurality of conductors 15 in the Y-Z plane.

Next, results of computer simulation for suppressing the leakage of the electromagnetic waves in post-wall waveguide 10 illustrated in FIGS. 2 to 6 will be described. In Embodiment 1, simulation is performed to calculate the frequency response of the transmission characteristic of post-wall waveguide 10 by three-dimensional electromagnetic field analysis using a finite integral method. For example, a port for input and output from the end portion of post-wall waveguide 10 in the negative direction of the X axis is referred to as port 1, and a port for input and output from the end portion in the positive direction of the X axis is referred to as port 2. In Embodiment 2 and subsequent embodiments to be described below, the same electromagnetic field analysis as in Embodiment 1 is performed.

In addition, for example, the following case is analyzed in the three-dimensional electromagnetic field analysis using the finite integral method in Embodiment 1: the thickness of dielectric layer 11 of post-wall waveguide 10 is set to 220 μm, the thicknesses of first conductor layer 12 and second conductor layer 13 between which dielectric layer 11 is interposed are set to 20 μm, the diameter of conductor via 14 is set to 60 μm, the interval (pitch) between conductor vias 14 is set to 170 μm, and the length of post-wall waveguide 10 is set to 2.5 mm. In addition, the shape of conductor 15 is set as a columnar shape, and the height of conductor 15 is set to 50 μm. The parameters of post-wall waveguide 10 used for the analysis are examples, and the present disclosure is not limited thereto.

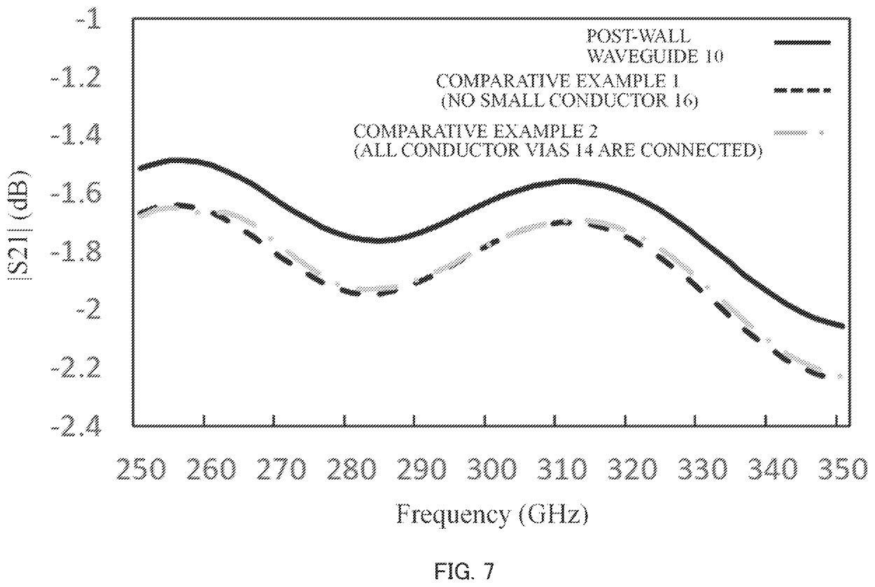

FIG. 7 illustrates an example of the frequency response of post-wall waveguide 10 according to Embodiment 1. FIG. 7 illustrates the frequency response of the transmission characteristic of post-wall waveguide 10 in the vicinity of 300 GHz. The horizontal axis of FIG. 7 represents the frequency axis, and the vertical axis represents the decibel value of the absolute value of S21, which is an S parameter indicating the transmission characteristic from port 1 to port 2. It is shown that as the value on the vertical axis of FIG. 7 is larger, the magnitude of the electromagnetic waves to be transmitted is larger.

FIG. 7 also illustrates the frequency response of the transmission characteristic of each of Comparative Example 1 and Comparative Example 2 as comparative examples. Comparative Example 1 has a configuration in which post-wall waveguide 10 includes no connection conductor 16 (referred to as a small conductor 16 in FIG. 7), and Comparative Example 2 has a configuration in which all conductor vias 14 are connected by connection conductor 16 in post-wall waveguide 10. The parameters of the configurations of Comparative Example 1 may be the same as the parameters of post-wall waveguide 10 described above except that connection conductor 16 is not provided. In addition, the parameters of the configurations of Comparative Example 2 may be the same as the parameters of post-wall waveguide 10 described above except that all conductor vias 14 are connected by the connection conductor.

As illustrated in FIG. 7, the frequency response of post-wall waveguide 10 indicates that the transmission characteristic thereof is higher than those of Comparative Example 1 and Comparative Example 2 in the illustrated frequency range. As described above, post-wall waveguide 10 has a configuration in which conductor vias 14 in the vicinity of conductor 15 are electrically connected by connection conductor 16, so that the suppression of the leakage of the electromagnetic waves and the reduction of the conductor loss can be simultaneously achieved, and the transmission characteristic can be improved over a wide band.

As described above, the reduction in loss caused by connecting conductor vias 14 by connection conductor 16 is due to the fact that connection conductor 16 suppresses the leakage of the electromagnetic waves to the outside of the waveguide. Next, an effect of suppressing the leakage of the electromagnetic waves to the outside of the waveguide is shown using an electric field distribution.

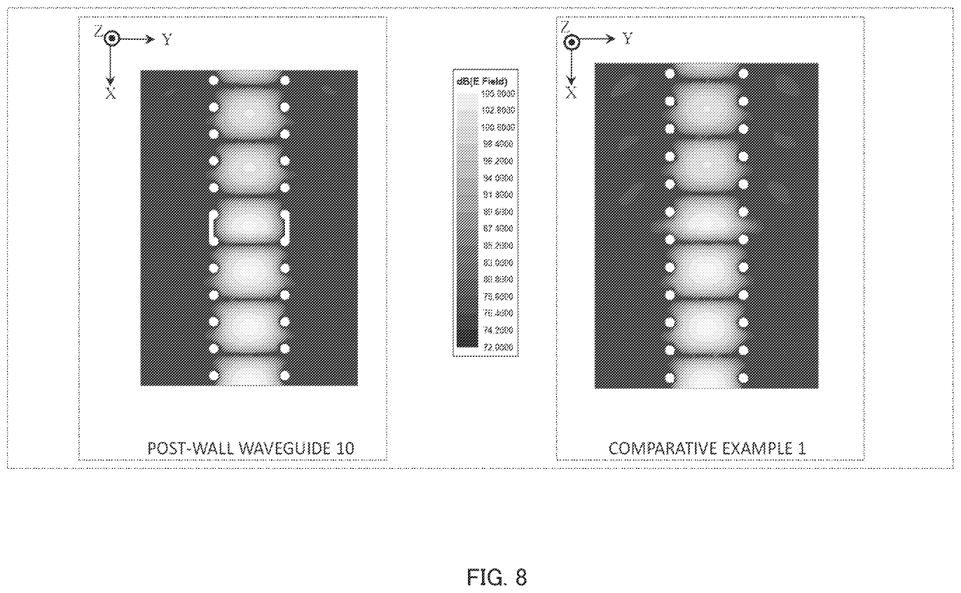

FIG. 8 illustrates an example of an electric field distribution in post-wall waveguide 10 according to Embodiment 1. FIG. 8 illustrates the electric field distribution in post-wall waveguide 10 and an electric field distribution in the configuration of Comparative Example 1. Each electric field distribution illustrated in FIG. 8 represents strength of the electric field in the horizontal plane (X-Y plane) of the waveguide by using shading.

As is clear from the comparison between the electric field distributions of post-wall waveguide 10 and the configuration of Comparative Example 1 in FIG. 8, connecting conductor vias 14 by connection conductor 16 can suppress the leakage of the electromagnetic waves to the outside of the waveguide.

As described above, post-wall waveguide 10 according to Embodiment 1 includes dielectric layer 11, first conductor layer 12 laminated on dielectric layer 11 in the lamination direction of dielectric layer 11, second conductor layer 13 laminated on the dielectric layer at a position different from the first conductor layer in the lamination direction, and the plurality of conductor vias 14 that electrically connect first conductor layer 12 with second conductor layer 13. Post-wall waveguide 10 includes connection conductor 16 that electrically connects the two or more conductor vias 14 provided in the vicinity of conductor 15 located in a waveguide portion-the waveguide portion is surrounded by first conductor layer 12, second conductor layer 13, and the plurality of conductor vias 14 and the electromagnetic waves pass through the waveguide portion. Conductor 15 is an example of the scatterer and is an example of a specific location where the scattering of the electromagnetic waves occurs.

According to post-wall waveguide 10 according to Embodiment 1, conductor vias 14 in the vicinity of conductor 15 that serves as the scatterer are connected by connection conductor 16, so that the at least two connected conductor vias 14 can be at the same potential as each other. Therefore, it is possible to suppress the scattering of the electromagnetic waves passing through the inside of the waveguide by conductor 15 and the leakage of the electromagnetic waves caused by the propagation between conductors 15, and it is possible to suppress the loss.

### Embodiment 2

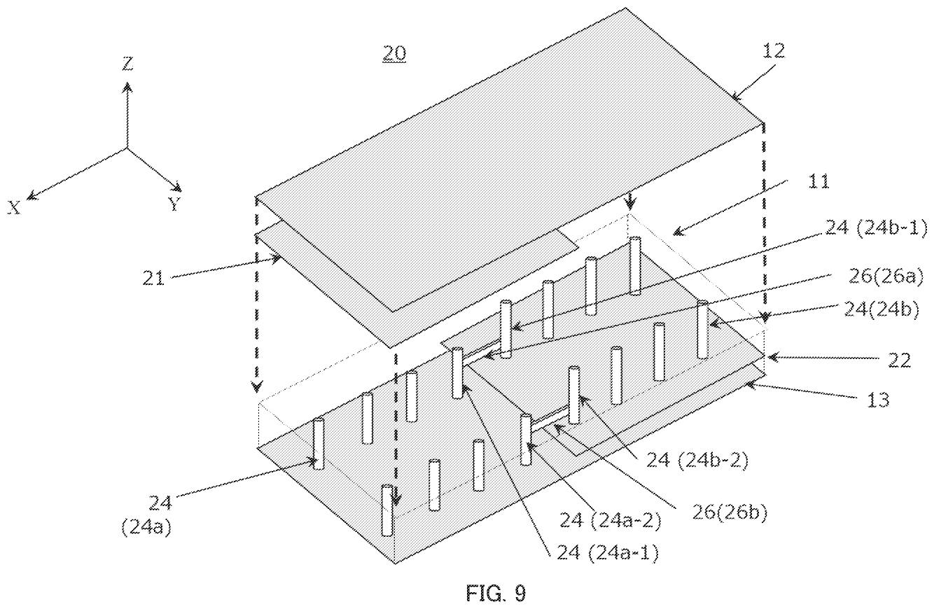

FIG. 9 is a perspective view illustrating an example of post-wall waveguide 20 according to Embodiment 2. FIG. 9 illustrates post-wall waveguide 20 and the X axis, the Y axis, and the Z axis provided with respect to post-wall waveguide 20. For convenience of illustration, FIG. 9 illustrates post-wall waveguide 20 with dielectric layer 11 seen through.

The X axis, the Y axis, and the Z axis are the same as the axes described in Embodiment 1, and thus the description thereof will be omitted.

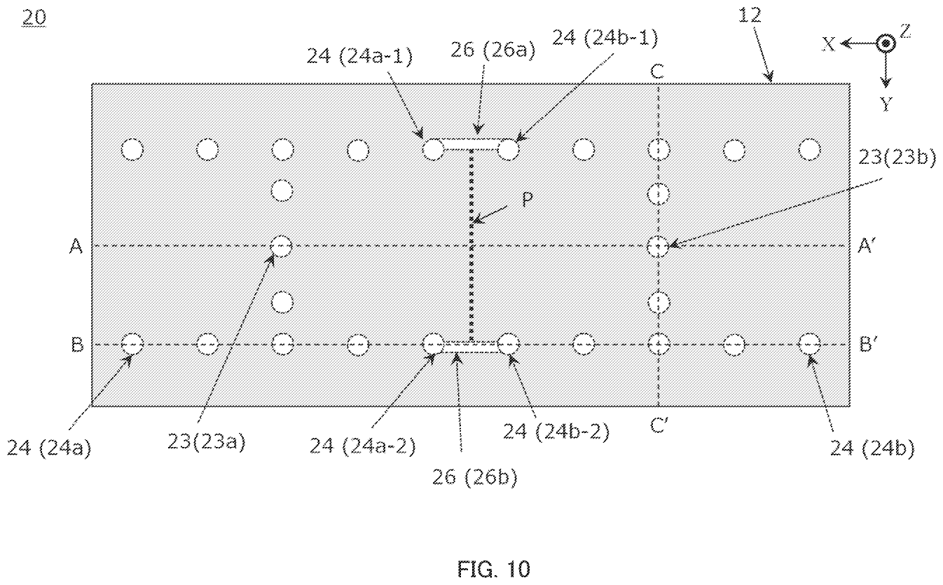

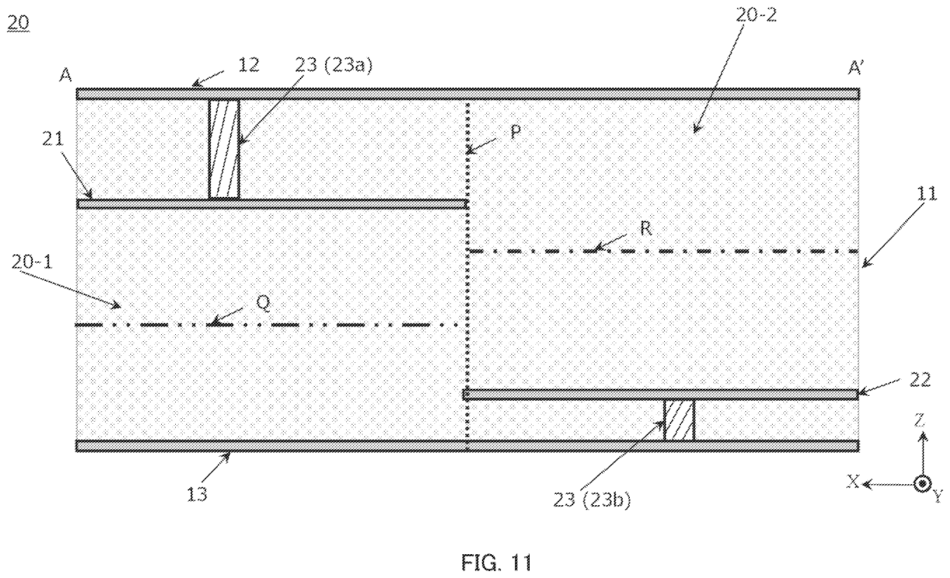

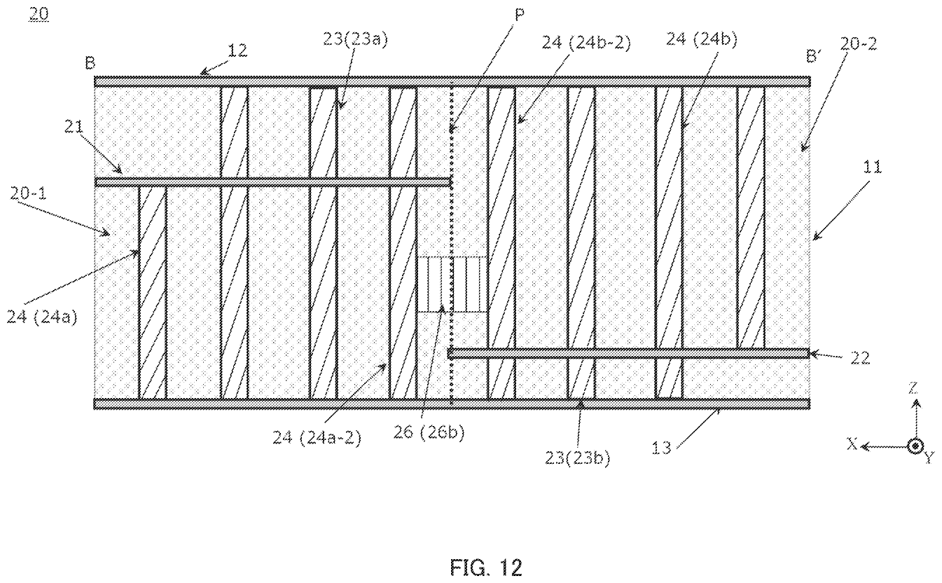

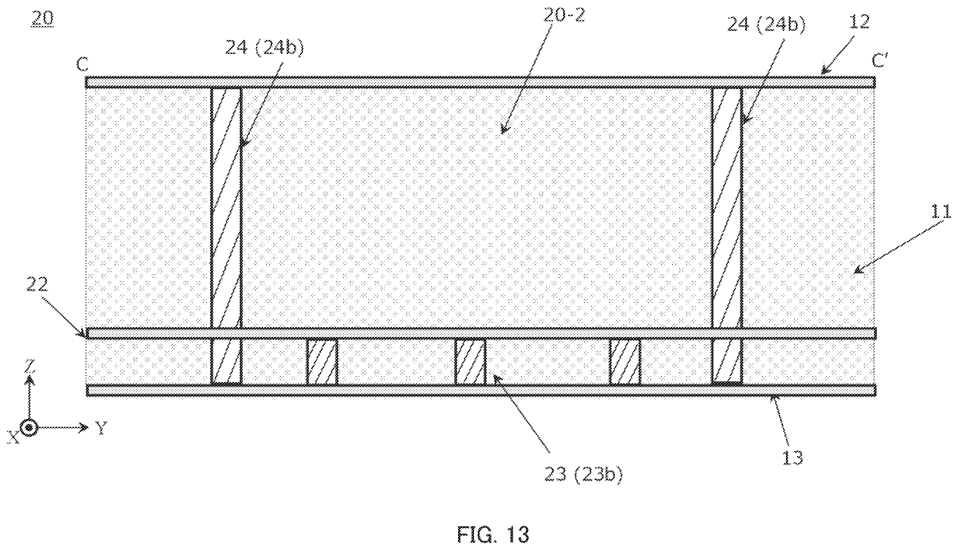

FIG. 10 is a top view of post-wall waveguide 20 according to Embodiment 2. FIG. 11 is an A-A′ cross-sectional view taken along line A-A′ of FIG. 10 and cut along the X-Z plane. FIG. 12 is a B-B′ cross-sectional view taken along line B-B′ of FIG. 10 and cut along the X-Z plane. FIG. 13 is a C-C′ cross-sectional view taken along line C-C′ of FIG. 10 and cut along the Y-Z plane. Post-wall waveguide 20 will be described with reference to FIGS. 9 to 13.

In FIGS. 9 to 13, the same components as the components of post-wall waveguide 10 according to Embodiment 1 (for example, FIGS. 2 to 6) may be denoted by the same reference numerals, and the description thereof may be omitted. In addition, boundary P illustrated in FIGS. 9 to 13 indicates a planar boundary along the Y-Z plane.

First conductor layer 12 is provided on the upper surface of dielectric layer 11, and second conductor layer 13 is provided on the lower surface of dielectric layer 11. First conductor layer 12 and second conductor layer 13 are parallel to each other.

Dielectric layer 11 is interposed between first conductor layer 12 and second conductor layer 13. Dielectric layer 11 may be one layer or may be composed of a plurality of dielectric layers.

Third conductor layer 21 and fourth conductor layer 22 are provided inside dielectric layer 11 between first conductor layer 12 and second conductor layer 13 in the thickness direction. Third conductor layer 21 is provided above fourth conductor layer 22 and extends from boundary P in the positive direction of the X axis. Fourth conductor layer 22 is provided below third conductor layer 21 and extends from boundary P in the negative direction of the X axis.

In post-wall waveguide 20 illustrated in FIGS. 9 to 13, third conductor layer 21 and fourth conductor layer 22 do not overlap in the top view from the positive direction of the Z axis.

Conductor via 24 extends in dielectric layer 11 along the thickness direction and electrically connects two conductor layers to each other. A plurality of conductor vias 24 face each other at a specific interval in the Y axis direction. In addition, the plurality of conductor vias 24 are provided so as to be arranged along the X axis. Conductor vias 24 include conductor vias 24a provided in a region in the positive direction of the X axis with respect to boundary P and conductor vias 24b provided in a region in the negative direction of the X axis with respect to boundary P. Conductor via 24a electrically connects second conductor layer 13 with third conductor layer 21. Conductor via 24b electrically connects first conductor layer 12 with fourth conductor layer 22.

Conductor via 23 extends in dielectric layer 11 along the thickness direction and electrically connects two conductor layers to each other. Conductor vias 23 include conductor vias 23a provided in a region in the positive direction of the X axis with respect to boundary P and conductor vias 23b provided in a region in the negative direction of the X axis with respect to boundary P. Conductor via 23a electrically connects first conductor layer 12 with third conductor layer 21. Conductor via 23b electrically connects second conductor layer 13 with fourth conductor layer 22.

Conductor via 23a and conductor via 23b are provided so as to be arranged along the Y axis and the X axis. Conductor vias 23a arranged along the X axis among conductor via 23a may be provided immediately above conductor vias 24a. Alternatively, conductor vias 23a arranged along the X axis may be integrally formed with conductor vias 24a, respectively. In this case, conductor via 24a may penetrate third conductor layer 21 to electrically connect first conductor layer 12 with second conductor layer 13. Similarly, conductor vias 23b arranged along the X axis may be integrally formed with conductor vias 24b, respectively.

In the region in the negative direction of the X axis with respect to boundary P illustrated in FIG. 11, the electromagnetic waves are transmitted in a range in dielectric layer 11—the range is surrounded by first conductor layer 12, fourth conductor layer 22, and conductor vias 24b. In addition, in the region in the positive direction of the X axis with respect to boundary P illustrated in FIG. 11, the electromagnetic waves are transmitted in a range in dielectric layer 11—the range is surrounded by second conductor layer 13, third conductor layer 21, and conductor vias 24a.

As described above, post-wall waveguide 20 illustrated in FIGS. 9 to 13 has a structure in which two post-wall waveguides are connected to each other.

For example, the region in the positive direction of the X axis with respect to boundary P illustrated in FIG. 11 is referred to as post-wall waveguide 20-1, and the region in the negative direction of the X axis with respect to boundary P is referred to as post-wall waveguide 20-2. In this case, as illustrated in FIG. 11, the center position of the waveguide portion of post-wall waveguide 20-1 in the thickness direction is indicated by line Q, and the center position of the waveguide portion of post-wall waveguide 20-2 in the thickness direction is indicated by line R. Line Q and line R are different from each other in the thickness direction of the waveguide portion.

As described above, post-wall waveguide 20 illustrated in FIGS. 9 to 13 has a structure in which post-wall waveguide 20-1 and post-wall waveguide 20-2 are connected to each other at boundary P. In post-wall waveguide 20-1 and post-wall waveguide 20-2, the thicknesses of the waveguide portions thereof are different from each other, and the center positions of the waveguide portions thereof are different from each other in the thickness direction.

The leakage of the electromagnetic waves in post-wall waveguide 20 occurs at a location in which the thickness of the waveguide portion and the center position of the waveguide portion are changed. The location in which the thickness of the waveguide portion and the center position of the waveguide portion are changed corresponds to an example of the scatterer. In addition, the location in which the thickness of the waveguide portion and the center position of the waveguide portion are changed may correspond to a location that at least partly scatters the electromagnetic waves and/or a location that is electrically discontinuous.

For example, in the examples of FIGS. 9 to 13, the vicinity of boundary P corresponds to the location in which the thickness of the waveguide portion and the center position of the waveguide portion are changed. In this case, the leakage of the electromagnetic waves in post-wall waveguide 20 is caused by the scattering of the electromagnetic waves by third conductor layer 21 and fourth conductor layer 22 in the vicinity of boundary P and the propagation of the electromagnetic waves along third conductor layer 21 and fourth conductor layer 22.

Connection conductor 26 connects conductor vias 24 located in the vicinity of end portions of third conductor layer 21 and fourth conductor layer 22 in the vicinity of boundary P. For example, conductor via 24a-1 and conductor via 24b-1 on the right side in the vicinity of boundary P are connected to each other by connection conductor 26a, and conductor via 24a-2 and conductor via 24b-2 on the left side in the vicinity of boundary P are connected to each other by connection conductor 26b.

In Embodiment 2, an example is shown in which the thicknesses of the waveguide portions of the two post-wall waveguides are different from each other and the center positions of the waveguide portions of the two post-wall waveguides are different from each other, but the present disclosure is not limited to thereto. For example, even when the thicknesses of the waveguide portions of the two post-wall waveguides are different from each other or the center positions of the waveguide portions of the two post-wall waveguides are different from each other, the loss can be suppressed by connecting conductor vias by the connection conductor as in post-wall waveguide 20—the conductor vias are located in the vicinity of the boundary where the thickness is changed or the boundary where the center position is changed. For example, in this case, the boundary where the thickness is changed or the boundary where the center position is changed may correspond to an example of the scatterer. The boundary where the thickness is changed or the boundary where the center position is changed may correspond to a location that at least partly scatters the electromagnetic waves and/or a location that is electrically discontinuous.

In addition, in post-wall waveguide 20, in order to suppress the leakage of the electromagnetic waves between first conductor layer 12 and third conductor layer 21 and the leakage of the electromagnetic waves between second conductor layer 13 and fourth conductor layer 22, conductor vias 23a are provided between first conductor layer 12 and third conductor layer 21, and conductor vias 23b are provided between second conductor layer 13 and fourth conductor layer 22.

The position where conductor via 23 is provided is not limited. For example, the position where conductor via 23 is provided may be set in such a way that the distance from boundary P to conductor via 23a and/or the distance from boundary P to conductor via 23b is a distance at which the reflected waves in the vicinity of boundary P are reduced. For example, the position of conductor via 23a and/or the position of conductor via 23b may be set to a position where the reflected waves in the vicinity of boundary P are minimized.

Although an example is shown in which conductor via 23a electrically connects first conductor layer 12 with third conductor layer 21 and an example is shown in which conductor via 23b electrically connects second conductor layer 13 with fourth conductor layer 22, the present disclosure is not limited to thereto. For example, when post-wall waveguide 20 is configured in a multilayer substrate, a plurality of conductor vias 23 (in which a conductor via is stacked immediately above the previous conductor via in the layers of the multilayer substrate) may electrically connect first conductor layer 12 with third conductor layer 21 or may electrically connect second conductor layer 13 with fourth conductor layer 22. For example, in Embodiment 2, the configuration in which the conductor via connects two conductor layers may be either of the following: one conductor via directly connects two conductor layers, or a plurality of conductor vias, in which a conductor via is stacked immediately above the previous conductor via in the layers of the multilayer substrate, connects two conductor layers.

Next, results of computer simulation for suppressing the leakage of the electromagnetic waves in post-wall waveguide 20 illustrated in FIGS. 9 to 13 will be described. The simulation method used in Embodiment 2 is the same as that in Embodiment 1.

In addition, for example, the following case is analyzed in the three-dimensional electromagnetic field analysis using the finite integral method in Embodiment 2: the thickness of dielectric layer 11 of post-wall waveguide 20 is set to 220 μm, the thicknesses of first conductor layer 12, second conductor layer 13, third conductor layer 21, and fourth conductor layer 22 are set to 20 μm, the diameters of conductor via 14 and conductor via 23 are set to 60 μm, the interval (pitch) between conductor vias 14 is set to 170 μm, and the length of post-wall waveguide 20 is set to 2.5 mm. The parameters of post-wall waveguide 20 used for the analysis are examples, and the present disclosure is not limited thereto.

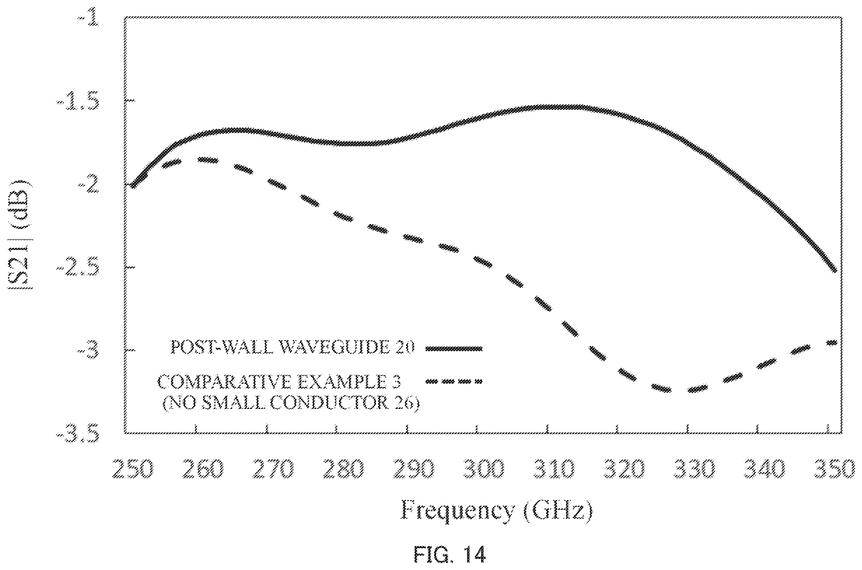

FIG. 14 illustrates an example of the frequency response of post-wall waveguide 20 according to Embodiment 2. FIG. 14 illustrates the frequency response of the transmission characteristic of post-wall waveguide 20 in the vicinity of 300 GHz. The horizontal axis of FIG. 14 represents the frequency axis, and the vertical axis represents a decibel value of an absolute value of S21, which is an S parameter indicating the transmission characteristic. It is shown that as the value on the vertical axis of FIG. 14 is larger, the magnitude of the electromagnetic waves to be transmitted is larger.

FIG. 14 also illustrates the frequency response of the transmission characteristic of Comparative Example 3 as a comparative example. Comparative Example 3 has a configuration in which post-wall waveguide 20 includes no connection conductor 26 (referred to as a small conductor 26 in FIG. 14). The parameters of the configurations of Comparative Example 3 may be the same as the parameters of post-wall waveguide 20 described above except that connection conductor 26 is not provided.

As illustrated in FIG. 14, the frequency response of post-wall waveguide 20 indicates that the transmission characteristic thereof is higher than that of Comparative Example 3 in the illustrated frequency range. As described above, post-wall waveguide 20 has a configuration in which conductor vias 24 in the vicinity of boundary P are electrically connected by connection conductor 26, so that the suppression of the leakage of the electromagnetic waves and the reduction of the conductor loss can be simultaneously achieved, and the transmission characteristic can be improved over a wide band.

As described above, the reduction in loss caused by connecting conductor vias 24 by connection conductor 26 is due to the fact that connection conductor 26 suppresses the leakage of the electromagnetic waves to the outside of the waveguide portion. Next, an effect of suppressing the leakage of the electromagnetic waves to the outside of the waveguide is shown using an electric field distribution.

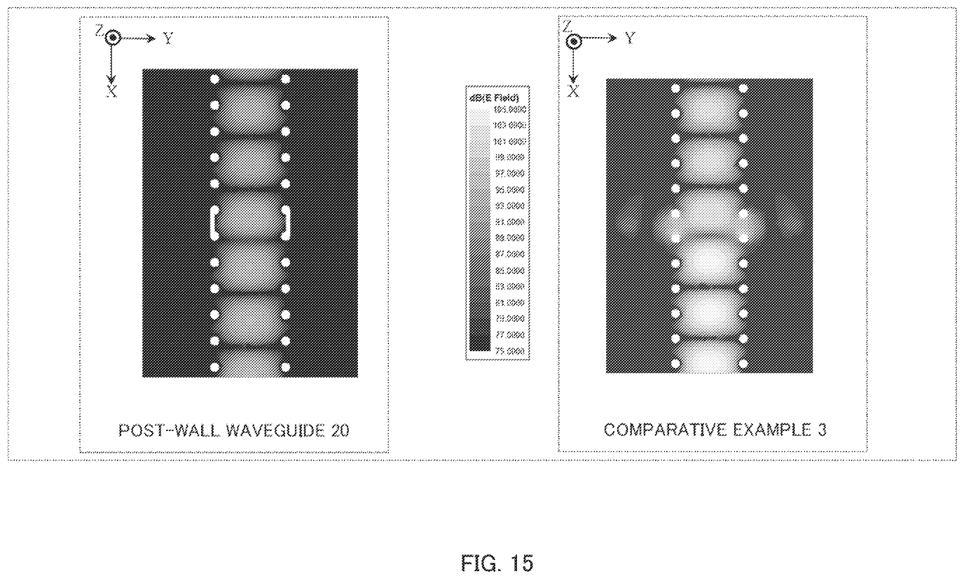

FIG. 15 illustrates an example of an electric field distribution in post-wall waveguide 20 according to Embodiment 2. FIG. 15 illustrates the electric field distribution in post-wall waveguide 20 and an electric field distribution in the configuration of Comparative Example 3. Each electric field distribution illustrated in FIG. 15 represents strength of the electric field in the horizontal plane (X-Y plane) of the waveguide by using shading.

As is clear from the comparison between the electric field distributions of post-wall waveguide 20 and the configuration of Comparative Example 3 in FIG. 15, connecting conductor vias 24 by connection conductor 26 can suppress the leakage of the electromagnetic waves to the outside of the waveguide.

In addition, in the related art, as the pitch is larger, the leakage of the electromagnetic field through gaps between conductor vias 24 is larger, so that the effect of leakage suppression by connection conductor 26 is also larger. Connection conductor 26 suppresses the leakage of the electromagnetic waves, so that the transmission characteristic can be improved over a wide band.

As described above, post-wall waveguide 20 according to Embodiment 2 includes dielectric layer 11, and first conductor layer 12, second conductor layer 13, third conductor layer 21, and fourth conductor layer 22 laminated on dielectric layer 11. First conductor layer 12, second conductor layer 13, third conductor layer 21, and fourth conductor layer 22 are laminated at different positions in the lamination direction. Post-wall waveguide 20 includes connection conductor 26 that electrically connects conductor vias 24 provided in the vicinity of the boundary where post-wall waveguide 20-1 and post-wall waveguide 20-2 are connected to each other. Post-wall waveguide 20-1 is surrounded by second conductor layer 13, third conductor layer 21, and conductor vias 24a, and the electromagnetic waves pass through post-wall waveguide 20-1. Post-wall waveguide 20-2 is surrounded by first conductor layer 12, fourth conductor layer 22, and conductor vias 24b, and the electromagnetic waves pass through post-wall waveguide 20-2. The boundary where post-wall waveguide 20-1 and post-wall waveguide 20-2 are connected to each other is an example of the scatterer and is an example of a specific location in which the scattering of the electromagnetic waves occurs.

According to post-wall waveguide 20 according to Embodiment 2, conductor vias 24 in the vicinity of boundary P corresponding to the scatterer are connected by connection conductor 26, so that the at least two connected conductor vias 24 can be at the same potential as each other. Therefore, it is possible to suppress the scattering of the electromagnetic waves in the vicinity of boundary P and the leakage of the electromagnetic waves, and it is possible to suppress the loss.

### Embodiment 3

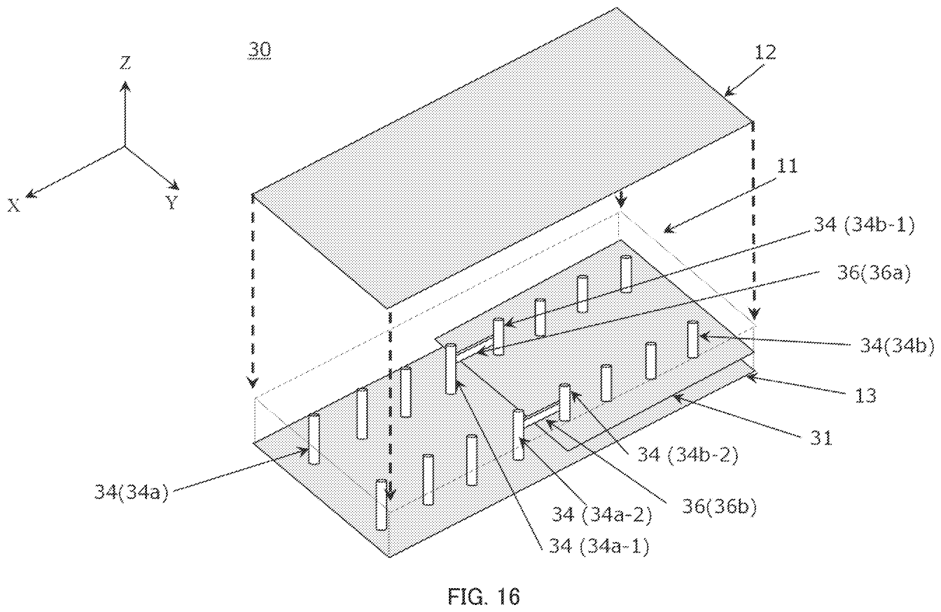

FIG. 16 is a perspective view illustrating an example of post-wall waveguide 30 according to Embodiment 3. FIG. 16 illustrates post-wall waveguide 30 and the X axis, the Y axis, and the Z axis provided with respect to post-wall waveguide 30. For convenience of illustration, FIG. 16 illustrates post-wall waveguide 30 with dielectric layer 11 seen through.

The X axis, the Y axis, and the Z axis are the same as the axes described in Embodiment 1, and thus the description thereof will be omitted.

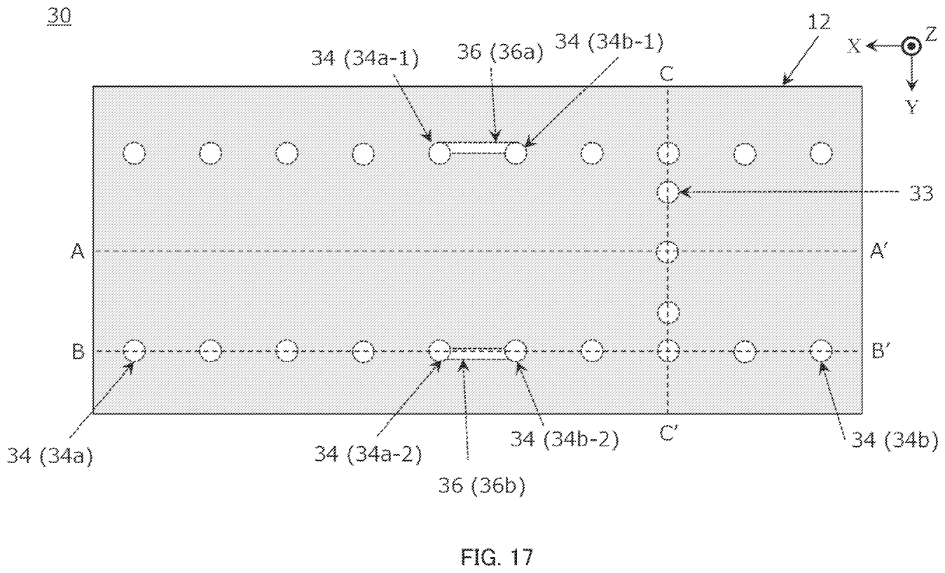

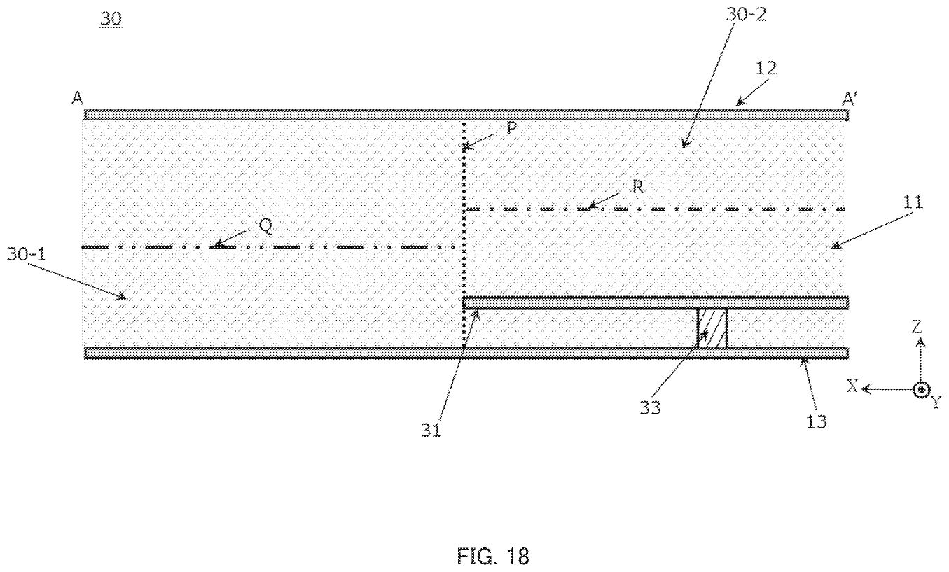

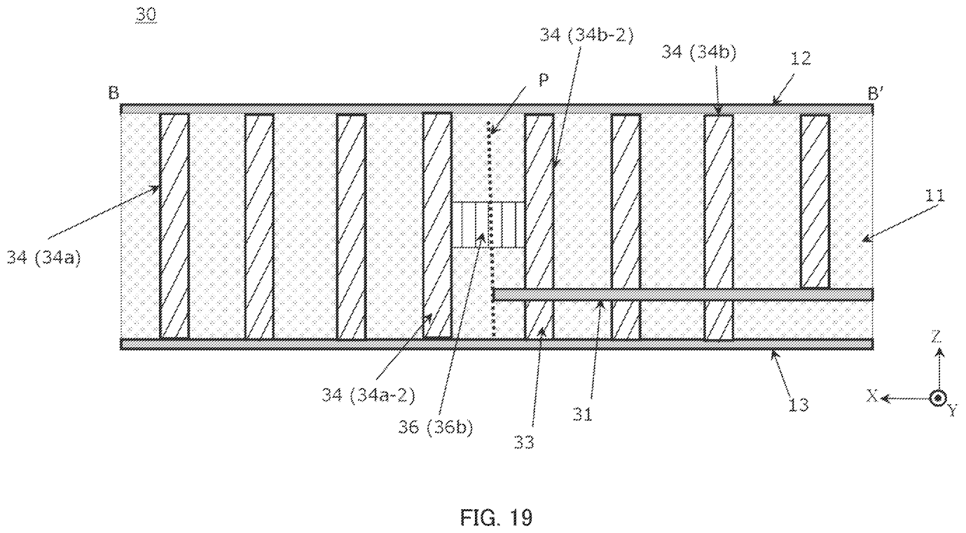

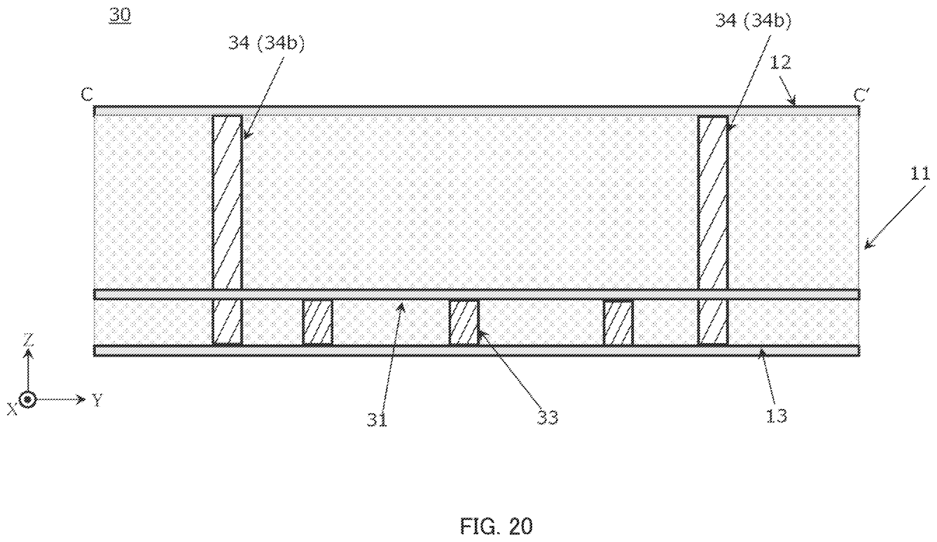

FIG. 17 is a top view of post-wall waveguide 30 according to Embodiment 3. FIG. 18 is an A-A′ cross-sectional view taken along line A-A′ of FIG. 17 and cut along the X-Z plane. FIG. 19 is a B-B′ cross-sectional view taken along line B-B′ of FIG. 17 and cut along the X-Z plane. FIG. 20 is a C-C′ cross-sectional view taken along line C-C′ of FIG. 17 and cut along the Y-Z plane. Post-wall waveguide 30 will be described with reference to FIGS. 16 to 20.

In FIGS. 16 to 20, the same components as the components of post-wall waveguide 10 according to Embodiment 1 (for example, FIGS. 2 to 6) may be denoted by the same reference numerals, and the description thereof may be omitted. In addition, boundary P illustrated in FIGS. 16 to 20 indicates a planar boundary along the Y-Z plane.

First conductor layer 12 is provided on the upper surface of dielectric layer 11, and second conductor layer 13 is provided on the lower surface of dielectric layer 11. First conductor layer 12 and second conductor layer 13 are parallel to each other.

Dielectric layer 11 is interposed between first conductor layer 12 and second conductor layer 13. Dielectric layer 11 may be one layer or may be composed of a plurality of dielectric layers.

Third conductor layer 31 is provided inside dielectric layer 11 between first conductor layer 12 and second conductor layer 13 in the thickness direction. Third conductor layer 31 extends from boundary P in the negative direction of the X axis.

Conductor via 34 extends in dielectric layer 11 along the thickness direction and electrically connects two conductor layers to each other. A plurality of conductor vias 34 face each other at a specific interval in the Y axis direction. In addition, the plurality of conductor vias 34 are provided so as to be arranged along the X axis. Conductor vias 34 include conductor vias 34a provided in a region in the positive direction of the X axis with respect to boundary P and conductor vias 34b provided in a region in the negative direction of the X axis with respect to boundary P. Conductor via 34a electrically connects first conductor layer 12 with second conductor layer 13. Conductor via 34b electrically connects first conductor layer 12 with third conductor layer 31.

Conductor via 33 extends in dielectric layer 11 along the thickness direction and electrically connects second conductor layer 13 with third conductor layer 31. Conductor vias 33 are provided so as to be arranged along the Y axis and the X axis. Conductor vias 33 arranged along the X axis among conductor vias 33 may be provided immediately below conductor vias 34b, respectively. Alternatively, conductor vias 33 arranged along the X axis may be integrally formed with conductor vias 34b, respectively. In this case, conductor via 34b may penetrate third conductor layer 31 to electrically connect first conductor layer 12 with second conductor layer 13.

In the region in the negative direction of the X axis with respect to boundary P illustrated in FIG. 18, the electromagnetic waves are transmitted in a range in dielectric layer 11—the range is surrounded by first conductor layer 12, third conductor layer 31, and conductor vias 34b. In addition, in the region in the positive direction of the X axis with respect to boundary P illustrated in FIG. 18, the electromagnetic waves are transmitted in a range in dielectric layer 11—the range is surrounded by first conductor layer 12, second conductor layer 13, and conductor vias 34a.

As described above, post-wall waveguide 30 illustrated in FIGS. 16 to 20 has a structure in which two post-wall waveguides are connected to each other. In addition, post-wall waveguide 30 includes a common first conductor layer 12 corresponding to the upper surface.

For example, the region in the positive direction of the X axis with respect to boundary P illustrated in FIG. 18 is referred to as post-wall waveguide 30-1, and the region in the negative direction of the X axis with respect to boundary P is referred to as post-wall waveguide 30-2. In this case, as illustrated in FIG. 18, the center position of the waveguide portion of post-wall waveguide 30-1 in the thickness direction is indicated by line Q, and the center position of the waveguide portion of post-wall waveguide 30-2 in the thickness direction is indicated by line R. Line Q and line R are different from each other in the thickness direction of the waveguide portion.

As described above, post-wall waveguide 20 illustrated in FIGS. 16 to 20 has a structure in which post-wall waveguide 30-1 and post-wall waveguide 30-2 are connected to each other at boundary P. In post-wall waveguide 30-1 and post-wall waveguide 30-2, the thicknesses of the waveguide portions thereof are different from each other, and the center positions of the waveguide portions thereof are different from each other in the thickness direction.

The leakage of the electromagnetic waves in post-wall waveguide 30 occurs at a location in which the thickness of the waveguide portion and the center position of the waveguide portion are changed. The location in which the thickness of the waveguide portion and the center position of the waveguide portion are changed corresponds to an example of the scatterer. In addition, the location in which the thickness of the waveguide portion and the center position of the waveguide portion are changed may correspond to a location that at least partly scatters the electromagnetic waves and/or a location that is electrically discontinuous.

For example, in the examples of FIGS. 16 to 20, the vicinity of boundary P corresponds to the location in which the thickness of the waveguide portion and the center position of the waveguide portion are changed. In this case, the leakage of the electromagnetic waves in post-wall waveguide 30 is caused by the scattering of the electromagnetic waves by third conductor layer 31 in the vicinity of boundary P and the propagation of the electromagnetic waves along third conductor layer 31.

Connection conductor 36 connects conductor vias 34 located in the vicinity of the end portion of third conductor layer 31 in the vicinity of boundary P. For example, conductor via 34a-1 and conductor via 34b-1 on the right side in the vicinity of boundary P are connected by connection conductor 36a, and conductor via 34a-2 and conductor via 34b-2 on the left side in the vicinity of boundary P are connected by connection conductor 36b.

In addition, in post-wall waveguide 30, in order to suppress the leakage of the electromagnetic waves between second conductor layer 13 and third conductor layer 31, conductor via 33 is provided between second conductor layer 13 and third conductor layer 31.

Next, results of computer simulation for suppressing the leakage of the electromagnetic waves in post-wall waveguide 30 illustrated in FIGS. 16 to 20 will be described. The simulation method used in Embodiment 3 is the same as that in Embodiment 1.

In addition, for example, the following case is analyzed in the three-dimensional electromagnetic field analysis using the finite integral method in Embodiment 3: the thickness of dielectric layer 11 of post-wall waveguide 30 is set to 220 μm, the thicknesses of first conductor layer 12, second conductor layer 13, and third conductor layer 31 are set to 20 μm, the diameters of conductor via 14 and conductor via 33 are set to 60 μm, the interval (pitch) between conductor vias 34 is set to 170 μm, and the length of post-wall waveguide 30 is set to 2.5 mm. The parameters of post-wall waveguide 30 used for the analysis are examples, and the present disclosure is not limited thereto.

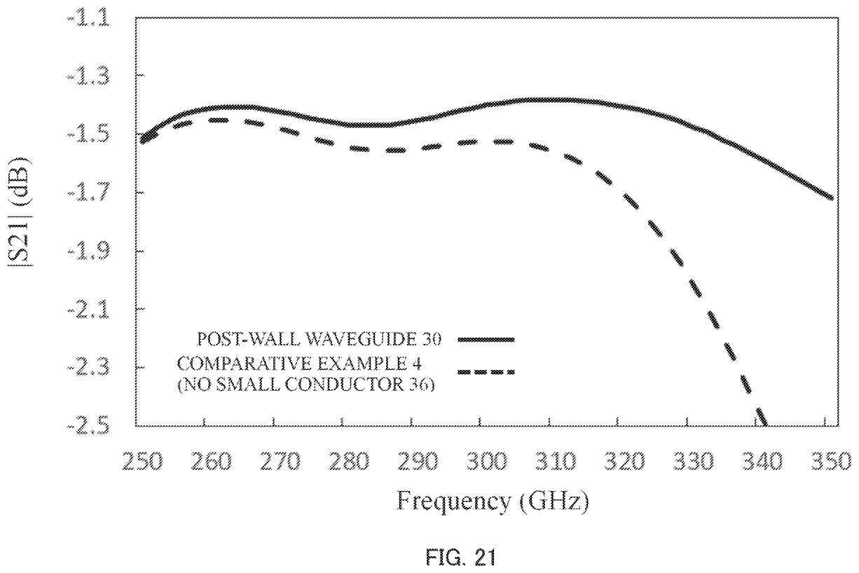

FIG. 21 illustrates an example of the frequency response of post-wall waveguide 30 according to Embodiment 3. FIG. 21 illustrates the frequency response of the transmission characteristic of post-wall waveguide 30 in the vicinity of 300 GHz. The horizontal axis of FIG. 21 represents the frequency axis, and the vertical axis represents a decibel value of an absolute value of S21, which is an S parameter indicating the transmission characteristic. It is shown that as the value on the vertical axis of FIG. 21 is larger, the magnitude of the electromagnetic waves to be transmitted is larger.

FIG. 21 also illustrates the frequency response of the transmission characteristic of Comparative Example 4 as a comparative example. Comparative Example 4 has a configuration in which post-wall waveguide 30 includes no connection conductor 36 (referred to as a small conductor 36 in FIG. 21). The parameters of the configurations of Comparative Example 4 may be the same as the parameters of post-wall waveguide 30 described above except that connection conductor 36 is not provided.

As illustrated in FIG. 21, the frequency response of post-wall waveguide 30 indicates that the transmission characteristic thereof is higher than that of Comparative Example 4 in the illustrated frequency range. As described above, post-wall waveguide 30 has a configuration in which conductor vias 34 in the vicinity of boundary P are electrically connected by connection conductor 36, so that the suppression of the leakage of the electromagnetic waves and the reduction of the conductor loss can be simultaneously achieved, and the transmission characteristic can be improved over a wide band.

As described above, the reduction in loss caused by connecting conductor vias 34 by connection conductor 36 is due to the fact that connection conductor 36 suppresses the leakage of the electromagnetic waves to the outside of the waveguide portion. Next, an effect of suppressing the leakage of the electromagnetic waves to the outside of the waveguide is shown using an electric field distribution.

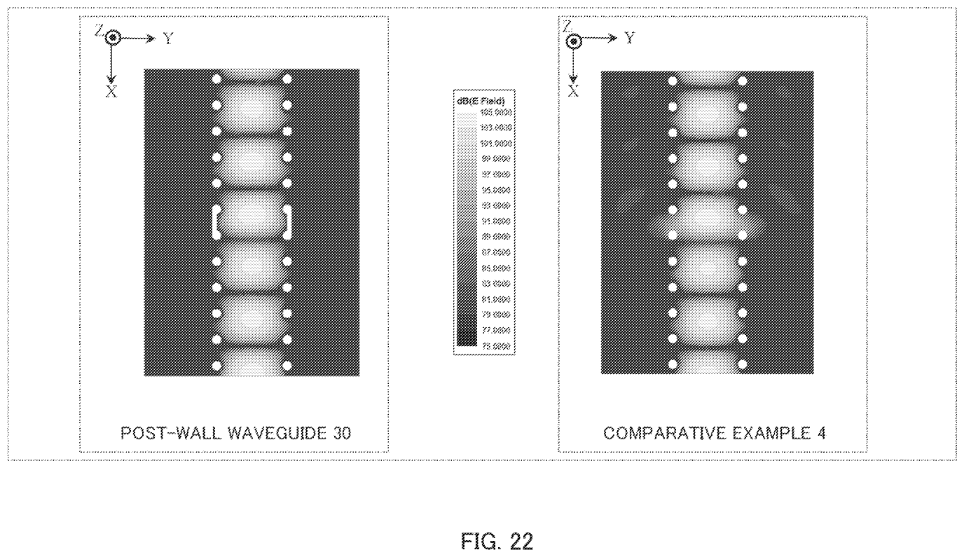

FIG. 22 illustrates an example of an electric field distribution in post-wall waveguide 30 according to Embodiment 3. FIG. 22 illustrates the electric field distribution in post-wall waveguide 30 and an electric field distribution in the configuration of Comparative Example 4. Each electric field distribution illustrated in FIG. 22 represents strength of the electric field in the horizontal plane (X-Y plane) of the waveguide by using shading.

As is clear from the comparison between the electric field distributions of post-wall waveguide 30 and the configuration of Comparative Example 4 in FIG. 22, connecting conductor vias 34 by connection conductor 36 can suppress the leakage of the electromagnetic waves to the outside of the waveguide.

As described above, post-wall waveguide 30 according to Embodiment 3 includes dielectric layer 11, and first conductor layer 12, second conductor layer 13, and third conductor layer 31 laminated on dielectric layer 11. Second conductor layer 13 and third conductor layer 31 are laminated at different positions in the lamination direction. Post-wall waveguide 30 includes connection conductor 36 that electrically connects conductor vias 34 provided in the vicinity of boundary P where post-wall waveguide 30-1 and post-wall waveguide 30-2 are connected to each other. Post-wall waveguide 30-1 is surrounded by first conductor layer 12, second conductor layer 13, and conductor vias 34a, and the electromagnetic waves pass through post-wall waveguide 30-1. Post-wall waveguide 30-2 is surrounded by first conductor layer 12, third conductor layer 31, and conductor vias 34b, and the electromagnetic waves passthrough post-wall waveguide 30-2. Boundary P where post-wall waveguide 30-1 and post-wall waveguide 30-2 are connected to each other is an example of the scatterer and is an example of a specific location in which the scattering of the electromagnetic waves occurs.

According to post-wall waveguide 30 according to Embodiment 3, conductor vias 34 in the vicinity of boundary P corresponding to the scatterer are connected by connection conductor 36, so that the at least two connected conductor vias 34 can be at the same potential as each other. Therefore, it is possible to suppress the scattering of the electromagnetic waves in the vicinity of boundary P and the leakage of the electromagnetic waves, and it is possible to suppress the loss.

### Embodiment 4

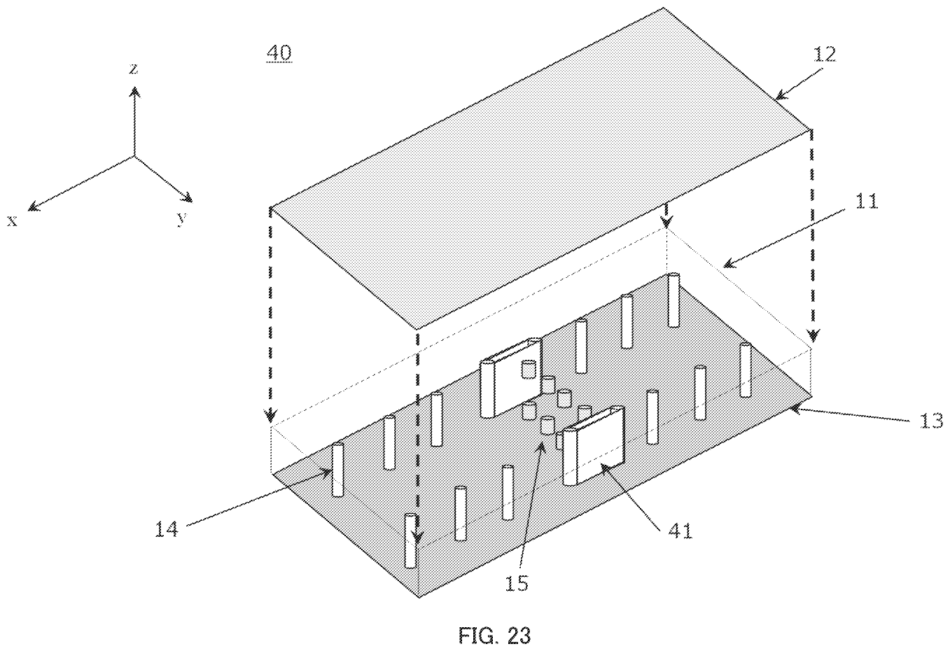

FIG. 23 is a perspective view illustrating an example of post-wall waveguide 40 according to Embodiment 4. FIG. 23 illustrates post-wall waveguide 40 and the X axis, the Y axis, and the Z axis provided with respect to post-wall waveguide 40. For convenience of illustration, FIG. 23 illustrates post-wall waveguide 40 with dielectric layer 11 seen through. In addition, in FIG. 23, the same components as the components of post-wall waveguide 10 shown in Embodiment 1 may be denoted by the same reference numerals, and the description thereof may be omitted.

The X axis, the Y axis, and the Z axis are the same as the axes described in Embodiment 1, and thus the description thereof will be omitted.

Post-wall waveguide 40 illustrated in FIG. 23 has a configuration in which connection conductor 16 and conductor vias 14 connected by connection conductor 16 in post-wall waveguide 10 according to Embodiment 1 are replaced with conductor via 41.

Conductor via 41 has a long side in the transmission direction of a signal (the positive direction or the negative direction of the X axis). Conductor via 41 is provided in the vicinity of conductors 15 serving as the scatterer, in the same manner as connection conductor 16 according to Embodiment 1. With this structure, it is possible to suppress the scattering of the electromagnetic waves passing through the waveguide portion by conductors 15 and the leakage of the electromagnetic waves caused by the propagation between conductors 15.

In FIG. 23, an example is illustrated in which conductor via 41 directly electrically connects first conductor layer 12 with second conductor layer 13, but the present disclosure is not limited to thereto. For example, when post-wall waveguide 40 is configured in a multilayer substrate, a plurality of conductor vias (in which a conductor via is stacked immediately above the previous conductor via in the layers of the multilayer substrate, and each conductor via has a long side in the positive direction or the negative direction of the X axis) may electrically connect first conductor layer 12 with second conductor layer 13.

Next, results of computer simulation for suppressing the leakage of the electromagnetic waves in post-wall waveguide 40 illustrated in FIG. 23 will be described. The simulation method used in Embodiment 4 is the same as that in Embodiment 1.

In addition, for example, the following case is analyzed in the three-dimensional electromagnetic field analysis using the finite integral method in Embodiment 4: the thickness of dielectric layer 11 of post-wall waveguide 40 is set to 220 μm, the thicknesses of first conductor layer 12 and second conductor layer 13 are set to 20 μm, the diameter of conductor via 14 is set to 60 μm, the interval (pitch) between conductor vias 14 is set to 170 μm, and the length of post-wall waveguide 40 is set to 2.5 mm. The parameters of post-wall waveguide 40 used for the analysis are examples, and the present disclosure is not limited thereto.

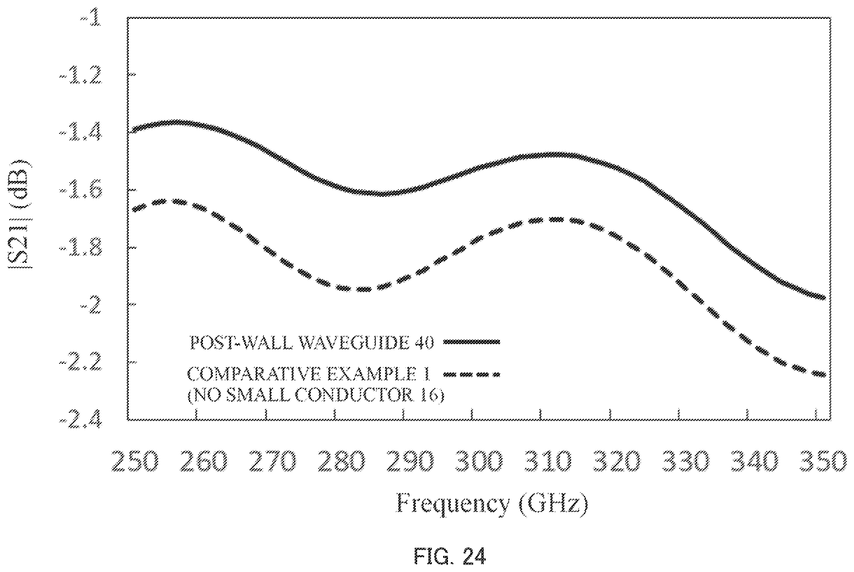

FIG. 24 illustrates an example of the frequency response of post-wall waveguide 40 according to Embodiment 4. FIG. 24 illustrates the frequency response of the transmission characteristic of post-wall waveguide 40 in the vicinity of 300 GHz. The horizontal axis of FIG. 24 represents the frequency axis, and the vertical axis represents a decibel value of an absolute value of S21, which is an S parameter indicating the transmission characteristic. It is shown that as the value on the vertical axis of FIG. 24 is larger, the magnitude of the electromagnetic waves to be transmitted is larger.

FIG. 24 also illustrates the frequency response of the transmission characteristic of Comparative Example 1 used in Embodiment 1 as a comparative example.

As illustrated in FIG. 24, the frequency response of post-wall waveguide 40 indicates that the transmission characteristic thereof is higher than that of Comparative Example 1 in the illustrated frequency range. As described above, post-wall waveguide 40 has a configuration in which conductor vias 14 in the vicinity of boundary P are electrically connected by connection conductor 16, so that the suppression of the leakage of the electromagnetic waves and the reduction of the conductor loss can be simultaneously achieved, and the transmission characteristic can be improved over a wide band.

As described above, the reduction in loss caused by conductor via 41 is due to the fact that conductor via 41 suppresses the leakage of the electromagnetic waves to the outside of the waveguide portion. Next, an effect of suppressing the leakage of the electromagnetic waves to the outside of the waveguide is shown using an electric field distribution.

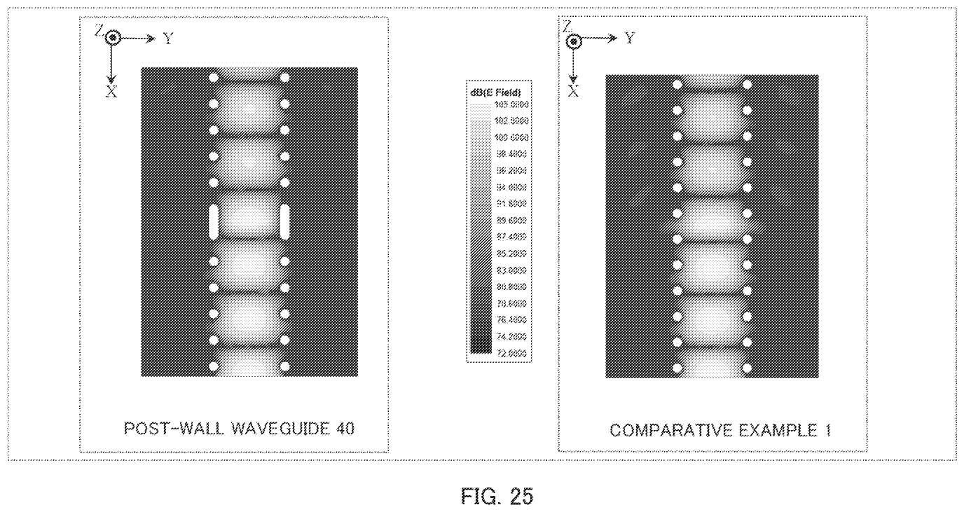

FIG. 25 illustrates an example of an electric field distribution in post-wall waveguide 40 according to Embodiment 4. FIG. 25 illustrates the electric field distribution in post-wall waveguide 40 and an electric field distribution in the configuration of Comparative Example 1. Each electric field distribution illustrated in FIG. 15 represents strength of the electric field in the horizontal plane (X-Y plane) of the waveguide by using shading.

As is clear from the comparison between the electric field distributions of post-wall waveguide 40 and the configuration of Comparative Example 1 in FIG. 25, the leakage of the electromagnetic waves to the outside of the waveguide can be suppressed by conductor via 41.

As described above, post-wall waveguide 40 according to Embodiment 4 has a configuration in which connection conductor 16 and conductor vias 14 connected by connection conductor 16 in post-wall waveguide 10 according to Embodiment 1 are replaced with conductor via 41. According to this configuration, conductor via 41 in the vicinity of conductors 15 serving as the scatterer has a structure having the long side in the traveling direction of the electromagnetic waves; and therefore, in the same manner as connection conductor 16 that connects the two conductor vias 14 in Embodiment 1, it is possible to suppress the scattering of the electromagnetic waves passing through the waveguide portion by conductors 15 and the leakage of the electromagnetic waves caused by the propagation between conductors 15, and it is possible to suppress the loss.

In addition, according to post-wall waveguide 40 according to Embodiment 4, since conductor via 41 penetrates dielectric layer 11 to connect first conductor layer 12 with second conductor layer 13 as in the other conductor vias 14, a manufacturing process of the post-wall waveguide can be simplified, and manufacturing costs can be reduced.

In addition, according to post-wall waveguide 40 according to Embodiment 4, since conductor via 41 blocks the gap between first conductor layer 12 and second conductor layer 13, the leakage of the electromagnetic waves can be more efficiently suppressed.

In each of the above-described embodiments, an example is shown in which one conductor via connects two conductor layers, but the present disclosure is not limited to thereto. When the post-wall waveguide is configured in a multilayer substrate, a plurality of conductor vias (in which a conductor via is stacked immediately above the previous conductor via in the layers of the multilayer substrate) may electrically connect may electrically connect two conductor layers.

In each of the above-described embodiments, an example is shown in which first conductor layer 12 and second conductor layer 13 are provided on the upper surface and the lower surface of dielectric layer 11, respectively, but the present disclosure is not limited to thereto. At least one of first conductor layer 12 and second conductor layer 13 may be provided on the surface of an inner layer of dielectric layer 11. For example, a case where first conductor layer 12 is provided on the surface of the inner layer of dielectric layer 11 may correspond to a case where a further layer of the dielectric is laminated above first conductor layer 12.

The post-wall waveguide may be simply referred to as a waveguide or a waveguide tube line. In addition, the post-wall waveguide may be referred to as a laminated waveguide or a laminated waveguide tube line. The electromagnetic wave may be replaced with a signal or a transmission signal.

### Summary of the Embodiments

A waveguide according to an embodiment of the present disclosure includes: a first conductor layer laminated on the dielectric layer in a lamination direction of the dielectric layer; a second conductor layer laminated on the dielectric layer at a position different from the first conductor layer in the lamination direction; a plurality of first conductor vias that electrically connect the first conductor layer with the second conductor layer; and a connector that electrically connects two or more second conductor vias with each other, the two or more second conductor vias being provided in a vicinity of a specific location in which scattering of an electromagnetic wave occurs, the specific location being located in a waveguide portion through which the electromagnetic wave passes and which is surrounded by the first conductor layer, the second conductor layer, and the plurality of first conductor vias.

In the waveguide, the specific location is a location in which a scatterer for scattering the electromagnetic wave is located.

In the waveguide, the scatterer is at least one of a conductor, a dielectric having a dielectric constant different from that of the dielectric layer, and a void.

In the waveguide, the scatterer has a shape selected from a prismatic shape, a columnar shape, a pyramidal shape, a conical shape, and a spherical shape, or a combined shape thereof.

In the waveguide, in the specific location, an area of a plane of the waveguide portion is equal to or more than 2 times an area of a plane of the scatterer, the planes being perpendicular to a traveling direction of the electromagnetic wave.

In the waveguide, in the waveguide portion, the specific location is a location in which at least one of a size, a shape, and a center position of a plane perpendicular to a traveling direction of the electromagnetic wave changes in the traveling direction.

In the waveguide, the first conductor layer includes a third conductor layer and a fourth conductor layer that are laminated on the dielectric layer at different positions in the lamination direction, and
the specific location is a boundary where a first waveguide portion and a second waveguide portion are in contact with each other, the first waveguide portion being a portion which is surrounded by the third conductor layer, the second conductor layer, and the plurality of first conductor vias and through which the electromagnetic wave passes, the second waveguide portion being a portion which is surrounded by the fourth conductor layer, the second conductor layer, and the plurality of first conductor vias and through which the electromagnetic wave passes.

In the waveguide, the first waveguide portion and the second waveguide portion share at least one dielectric layer.

In the waveguide, the first conductor layer includes a third conductor layer and a fourth conductor layer that are laminated on the dielectric layer,
the second conductor layer includes a fifth conductor layer and a sixth conductor layer that are laminated on the dielectric layer,
the third conductor layer, the fourth conductor layer, the fifth conductor layer, and the sixth conductor layer are laminated at different positions in the lamination direction, and
the specific location is a boundary where a first waveguide portion and a second waveguide portion are in contact with each other, the first waveguide portion being a portion which is surrounded by the third conductor layer, the fifth conductor layer, and the plurality of first conductor vias and through which the electromagnetic wave passes, the second waveguide portion being a portion which is surrounded by the fourth conductor layer, the sixth conductor layer, and the plurality of first conductor vias and through which the electromagnetic wave passes.

In the waveguide, the first waveguide portion and the second waveguide portion share at least one dielectric layer.

In the waveguide, the connector is a conductor that is integrally formed with the two or more first conductor vias and that has a long side in a direction along a traveling direction of the electromagnetic wave passing through the waveguide portion.

Various embodiments have been described with reference to the drawings hereinabove; however, the present disclosure is not limited to these examples. Obviously, a person skilled in the art would arrive at variations and modification examples within a scope described in claims, and it is understood that these variations and modifications are within the technical scope of the present disclosure. The constituent elements of the above-mentioned embodiments may be combined optionally without departing from the spirit of the disclosure.

This application is entitled to and claims the benefit of Japanese Patent Application No. 2023-026210 filed on Feb. 22, 2023, the disclosure of which including the specification, drawings and abstract is incorporated herein by reference in its entirety.

### INDUSTRIAL APPLICABILITY

An embodiment of the present disclosure is suitable for use in a waveguide.

### REFERENCE SIGNS LIST

10, 20, 30, 40 Post-wall waveguide
11 Dielectric layer
12 First conductor layer
13 Second conductor layer
14, 23, 24, 33, 34, 41 Conductor via
15 Conductor
16, 26, 36 Connection conductor
21 Third conductor layer
22 Fourth conductor layer

1. A waveguide comprising:
a dielectric layer;
a first conductor layer laminated on the dielectric layer in a lamination direction of the dielectric layer;
a second conductor layer laminated on the dielectric layer at a position different from the first conductor layer in the lamination direction;
a plurality of first conductor vias that electrically connect the first conductor layer with the second conductor layer; and
a connector that electrically connects two or more second conductor vias with each other, the two or more second conductor vias being provided in a vicinity of a specific location in which scattering of an electromagnetic wave occurs, the specific location being located in a waveguide portion through which the electromagnetic wave passes and which is surrounded by the first conductor layer, the second conductor layer, and the plurality of first conductor vias.
(in a waveguide portion through which an electromagnetic wave passes and which is surrounded by the first conductor layer, the second conductor layer, and the plurality of first conductor vias, a connector that electrically connects two or more second conductor vias with each other, the two or more second conductor vias being provided in a vicinity of a specific location in which scattering of the electromagnetic wave occurs.)

2. The waveguide according to claim 1, wherein
the specific location is a location in which a scatterer for scattering the electromagnetic wave is located.

3. The waveguide according to claim 2, wherein
the scatterer is at least one of a conductor, a dielectric having a dielectric constant different from that of the dielectric layer, and a void.

4. The waveguide according to claim 2, wherein
the scatterer has a shape selected from a prismatic shape, a columnar shape, a pyramidal shape, a conical shape, and a spherical shape, or a combined shape thereof.

5. The waveguide according to claim 2, wherein
in the specific location, an area of a plane of the waveguide portion is equal to or more than 2 times an area of a plane of the scatterer, the planes being perpendicular to a traveling direction of the electromagnetic wave.

6. The waveguide according to claim 1, wherein
in the waveguide portion, the specific location is a location in which at least one of a size, a shape, and a center position of a plane perpendicular to a traveling direction of the electromagnetic wave changes in the traveling direction.

7. The waveguide according to claim 1, wherein:
the first conductor layer includes a third conductor layer and a fourth conductor layer that are laminated on the dielectric layer at different positions in the lamination direction; and
the specific location is a boundary where a first waveguide portion and a second waveguide portion are in contact with each other, the first waveguide portion being a portion which is surrounded by the third conductor layer, the second conductor layer, and the plurality of first conductor vias and through which the electromagnetic wave passes, the second waveguide portion being a portion which is surrounded by the fourth conductor layer, the second conductor layer, and the plurality of first conductor vias and through which the electromagnetic wave passes.

8. The waveguide according to claim 7, wherein
the first waveguide portion and the second waveguide portion share at least one dielectric layer.

9. The waveguide according to claim 1, wherein:
the first conductor layer includes a third conductor layer and a fourth conductor layer that are laminated on the dielectric layer;
the second conductor layer includes a fifth conductor layer and a sixth conductor layer that are laminated on the dielectric layer;
the third conductor layer, the fourth conductor layer, the fifth conductor layer, and the sixth conductor layer are laminated at different positions in the lamination direction; and
the specific location is a boundary where a first waveguide portion and a second waveguide portion are in contact with each other, the first waveguide portion being a portion which is surrounded by the third conductor layer, the fifth conductor layer, and the plurality of first conductor vias and through which the electromagnetic wave passes, the second waveguide portion being a portion which is surrounded by the fourth conductor layer, the sixth conductor layer, and the plurality of first conductor vias and through which the electromagnetic wave passes.

10. The waveguide according to claim 9, wherein
the first waveguide portion and the second waveguide portion share at least one dielectric layer.

11. The waveguide according to claim 1, wherein
the connector is a conductor that is integrally formed with the two or more first conductor vias and that has a long side in a direction along a traveling direction of the electromagnetic wave passing through the waveguide portion.
